(19) United States
(12) Patent Application Publication
(10) Pub. No.: US 2006/0239540 A1
(43) Pub. Date: Oct. 26, 2006

(54) Methods and systems for creating 4D images using multiple 2D images acquired in real-time ("4D ultrasound")

(75) Inventors: Luis Serra, Singapore (SG); Chua Beng Choon, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, S.p.A., Milano (IT)

(21) Appl. No.: 11/373,642

(22) Filed: Mar. 9, 2006

Related U.S. Application Data
(60) Provisional application No. 60/660,563, filed on Mar. 9, 2005.

(51) Int. Cl. G06K 9/00

(52) U.S. Cl. 382/154

(57) ABSTRACT

Methods and systems for rendering high quality 4D ultrasound images in real time, without the use of expensive graphics hardware, without resampling, but also without lowering the resolution of acquired image planes, are presented. In exemplary embodiments according to the present invention, 2D ultrasound image acquisitions with known three dimensional (3D) positions can be mapped directly into corresponding 2D planes. The images can then be blended from back to front towards a user's viewpoint to form a 3D projection. The resulting 3D images can be updated in substantially real time to display the acquired volumes in 4D.

### CROSS-REFERENCE TO RELATED APPLICATIONS

This application claims the benefit of U.S. Provisional Patent Application No. 60/660,563, filed on Mar. 9, 2005, which is hereby incorporated herein by reference. Additionally, this application incorporates by reference U.S. Utility patent application Ser. No. 10/744,869, filed on Dec. 22, 2003, entitled Dynamic Display of 3D Ultrasound (“UltraSonar”), as well as U.S. Utility patent application Ser. No. 11/172,729, filed on Jul. 1, 2005, entitled “System and Method for Scanning and Imaging Management Within a 3D Space (“SonoDEX”).

### TECHNICAL FIELD

The present invention relates to the field of medical imaging, and more particularly to the efficient creation of four-dimensional images of a time-varying three-dimensional data set.

### BACKGROUND OF THE INVENTION

Two-dimensional (2D) ultrasound imaging has traditionally been used in medical imaging applications to visualize slices of a patient organ or other area of interest. Thus, in a conventional 2D medical ultrasound examination, for example, an image of an area of interest can be displayed on a monitor placed next to a user. Such user can be, for example, a radiologist or an ultrasound technician (often referred to as a “sonographer”). The image on the monitor generally depicts a 2D image of the tissue positioned under the ultrasound probe as well as the position in 3D of the ultrasound probe. The refresh rate of such an image is usually greater than 20 frames/second.

The conventional method described above does not offer a user any sense of three dimensionality. There are no visual cues as to depth perception. The sole interactive control a user has over the imaging process is the choice of which cross-sectional plane to view within a given field of interest. The position of the ultrasound probe determines which two-dimensional plane is seen by a user.

Recently, volumetric ultrasound image acquisition has become available in ultrasound imaging systems. Several ultrasound system manufacturers, such as, for example, GE, Siemens and Toshiba, to name a few, offer such volumetric 3D ultrasound technology. Exemplary applications for 3D ultrasound range from viewing a prenatal fetus to hepatic, abdominal and cardiological ultrasound imaging.

Methods used by such 3D ultrasound systems, for example, track, or calculate the spatial position of an ultrasound probe during image acquisition while simultaneously recording a series of images. Thus, using a series of acquired two-dimensional images and information as to their proper sequence, a volume of a scanned bodily area can be reconstructed. This volume can then be displayed as well as segmented using standard image processing tools. Current 4D probes typically reconstruct such a volume in real-time, at 10 frames per second, and some newer probes even claim significantly better rates.

Certain three-dimensional (3D) ultrasound systems have been developed by modifying 2D ultrasound systems. 2D ultrasound imaging systems often use a line of sensors to scan a two-dimensional (2D) plane and produce 2D images in real-time. These images can have, for example, a resolution of 200×400 while maintaining real-time display. To acquire a three-dimensional (3D) volume a number of 2D images must be acquired. This can be done in several ways. For example, using a motor a line of sensors can be swept over a volume in a direction perpendicular to the line of sensors (and thus the scan planes sweep through the volume) several times per second. FIG. 1 depicts an exemplary motorized probe which can be used for this technique. For an exemplary acquisition rate of 4 to 10 volumes per second, the sweep of the probe has to cover the entire volume that is to be scanned in 0.1-0.25 seconds, respectively.

Alternatively, a probe can be made with several layers of sensors, or with a matrix of sensors such as those manufactured by Philips (utilizes a matrix of traditional ultrasound sensors) or Sensant (utilizes silicon sensors). As a rough estimate of the throughput required for 3D ultrasound imaging, using, for example, 100 acquired planes per volume, a probe needs to acquire 100 2D images for processing in 0.1-0.25 seconds, and then make them visible on the screen. At a resolution of 200×400 pixels/plane, and 1 byte per pixel this can require a data throughput of up to 8 Mbytes/0.1 sec, or 640 Mbits/sec.

In general, in an ultrasound system data needs to travel from a probe to some buffer in the system for processing before being sent onto the system bus. The data then travels along such system bus into a graphics card. Thus, in order to be able to process the large amounts of data generated by an ultrasound probe in conventional 3D ultrasound systems, these systems must compromise image quality to reduce the large quantities of data. This is usually done by reducing the resolution of each 2D acquisition plane and/or by using lower resolution probes solely for 3D ultrasound. This compromise is a necessity for reasons of both bus speed as well as rendering speed, inasmuch as the final result has to be a 3D (4D) moving image that moves at least as fast as the movements of the phenomenon in the imaged object or organ that one is trying to observe (such as, for example, a fetus' hand moving, a heart beating, etc.) Lowering the data load is thus necessary because current technology does not have the ability to transfer and process the huge quantity of 3D ultrasound signal quickly enough in real-time.

Although emerging data transfer technologies may improve the rate of data transfer to a graphics card, the resolution of ultrasound probes will also correspondingly improve, thus increasing the available data that needs to be transferred. Thus, 3D imaging techniques that fully exploit the capability of ultrasound technology are not likely to occur, inasmuch as every advance in data transfer rates must deal with an increase in acquired data from improvements to probe technologies. Moreover, the gap between throughput rates and available data will only continue to increase. A two-fold increase in resolution of a 2D ultrasound plane (e.g., from 128×128 pixels to 256×256 pixels) results in a four-fold increase in the amount of data per image plane. If this is further compounded with an increase in slices per unit volume, the data coming in from the ultrasound probe begins to swamp the data transfer capabilities.

In addition, such a conventional system must also compromise on the number of planes acquired from a given area to maintain a certain volumes per second rate (4 vols/sec is the minimum display rate commercially acceptable). Even at low resolution, enough planes to be able to visualize the organ or pathology of interest, and match the x-y resolution plane are still required. For example, if it is desired to “resolve” (i.e., be able to see) a 5 mm vessel, then several planes should cut the longitudinal axis of the vessel; optimally, at least 3 planes. Thus, such a system would need to obtain one plane at least every mm. If the total scan volume is 1 cm, then 10 planes would be required.

Conventionally, there are several typical stages in getting acquired data to the display screen of an ultrasound imaging system. An exemplary approach commonly used is illustrated in FIG. 2. With respect thereto, acquired ultrasound planes 201 go through a “resampling” process into a rectangular volume at 210. Resampling converts acquired data received from a probe as a series of 2D planes with known relative positions (for example, such as those comprising the slices of a solid arc, as in the motorized sweep shown in FIG. 1 above) into a regular rectangular shape that can lend itself to conventional volume rendering. Resampling to a regular rectangular shape is necessary because conventional volume rendering (“VR”) has been developed assuming regular volumes as inputs, such as those generated by, for example, CT or MR scanners. Thus, conventional VR algorithms assume the input is a regular volume.

Resampling 210 can often be a time-consuming process. More importantly, resampling introduces sampling errors due to, for example, (i) the need to interpolate more between distantly located voxels (such as occurs at the bottom of the imaged object, where the ultrasound planes are farther apart) than near ones, producing a staircase effect, or (ii) the fact that downsampling computes the value of an element of information based on its surrounding information. Resampling generally utilizes an interpolation method such as a linear interpolation to obtain a “good approximation.” There is always a difference between a “good approximation” and the information as actually acquired, and this results in sampling errors. Sampling errors can lower the quality of a final image. After resampling, data can be, for example, transferred to a graphics card or other graphics processing device for volume rendering 220.

4D ultrasound imaging systems render in substantially real-time 3D volumes that are dynamic. This technique is highly desirable in medical applications, as it can allow the visualization of a beating heart, a moving fetus, the permeation of a contrast agent through a liver, etc. Depending on the size of the final volume matrix, a 4D VR process generally needs to be performed by hardware-assisted rendering methods, such as, for example, 3D texturing. This is because a single CPU has to process a volume (i.e., a cubic matrix of voxels) and simulate the image that would be seen by an observer. This involves casting rays which emanate from the viewpoint of the observer and recording their intersection with the volume's voxels. The information obtained is then projected onto a screen (a 2D matrix of pixels where a final image is produced). The collected information of the voxels along the line of the cast ray can be used to produced different types of projections, or visual effects. A common projection is the blending of voxel intensities together from back to front. This technique simulates the normal properties of light interacting with an object that can be seen with human eyes. Other common projections include finding the voxels with maximum value (Maximum Intensity Projection), or minimum value, etc.

The limiting factor in processing this data is the sheer number of voxels that need processing, and the operations that need to be performed on them. Hardware-assisted rendering methods are essential for this process because a pure software method is many times slower (typically in the order of 10 to 100 times slower), making it highly undesirable for 4D rendering. Hardware assistance can require, for example, an expensive graphics card or other graphics processing device that is not always available in an ultrasound imaging system, especially in lower end, portable ultrasound imaging units or wrist-based imaging units. If no hardware-assisted rendering is available, in order to render a volume in real-time, an ultrasound system must lower the quality of image acquisition by lowering the number of pixels per plane as well as the overall number of acquired planes, as described above. Such an ultrasound acquisition system is thus generally set to acquire lower resolution data.

What is thus needed in the art is a system and method to provide a fast way to render high quality 4D ultrasound images in real-time without (i) expensive graphics hardware, (ii) the time consuming and error-inducing stage of resampling, or (ii) the need to lower the quality of acquired image planes. Such a method would allow a system to fully utilize all of the available data in its imaging as opposed to throwing significant quantities of it away.

### SUMMARY OF THE INVENTION

Methods and systems for rendering high quality 4D ultrasound images in real time, without the use of expensive graphics hardware, without resampling, but also without lowering the resolution of acquired image planes, are presented. In exemplary embodiments according to the present invention, 2D ultrasound image acquisitions with known three dimensional (3D) positions can be mapped directly into corresponding 2D planes. The images can then be blended from back to front towards a user's viewpoint to form a 3D projection. The resulting 3D images can be updated in substantially real time to display the acquired volumes in 4D.

### BRIEF DESCRIPTION OF THE DRAWINGS

FIG. 1 illustrates a conventional motorized ultrasound probe;

FIG. 2 depicts a conventional 3D volume rendering of a plurality of acquired ultrasound planes;

FIGS. 3(a) and 3(b) illustrate an exemplary resampling of a motorized ultrasound sensor sweep acquisition;

FIG. 4 depicts an exemplary direct mapping of acquired ultrasound planes for 2D texture plus blending rendering according to an exemplary embodiment of the present invention;

FIG. 5 depicts an exemplary process flow chart for four dimensional (4D) volume rendering according to an exemplary embodiment of the present invention;

FIG. 6(a) illustrates an exemplary parallel acquisition of 2D ultrasound images;

FIG. 6(b) illustrates an exemplary non-parallel acquisition of 2D ultrasound images;

FIG. 7 depicts an exemplary display of ultrasound images over a checkerboard background, using 100% and 75% opacity values;

FIG. 8 depicts an exemplary display of ultrasound images over a checkerboard background, using 50% and 25% opacity values;

FIG. 9 illustrates an exemplary ultrasound image with regions of interest segmented out by adjusting opacity values according to an exemplary embodiment of the present invention;

FIG. 10 illustrates an exemplary ultrasound image with a three dimensional appearance created by rendering and blending multiple images according to an exemplary embodiment of the present invention;

FIG. 11 depicts additional illustrations of a three dimensional appearance created for ultrasound images by rendering and blending multiple images according to an exemplary embodiment of the present invention;

FIGS. 12-20 depict comparisons of conventional 4D ultrasound images created using volume rendering (left sides) with exemplary images created according to the method of the present invention, at varying viewpoints.

FIG. 21 depicts an exemplary system according to an exemplary embodiment of the present invention;

FIG. 22 depicts an alternative exemplary system according to an exemplary embodiment of the present invention;

FIG. 23 depicts an exemplary transformation of ultrasound image pixels to virtual world dimensions according to an exemplary embodiment of the present invention;

FIG. 24 depicts an exemplary texture mapping of an acquired ultrasound image onto a polygon in a virtual world according to an exemplary embodiment of the present invention;

FIG. 25 depicts transforming the exemplary textured polygon of FIG. 24 into virtual world coordinates according to an exemplary embodiment of the present invention;

FIG. 26 depicts multiple 2D images acquired and transformed as in FIGS. 24-26 according to an exemplary embodiment of the present invention;

FIG. 27 depicts an exemplary set of slices acquired in an ultrasound examination;

FIG. 28 depicts a comparison of the of the amount of information required to be processed in each of a conventional 4D ultrasound interpolated volume and according to an exemplary embodiment of the present invention;

FIG. 29 depicts the characteristics of exemplary ultrasound slices used in the comparisons of FIGS. 30-34;

FIG. 30 is a graph depicting the results of a rendering time comparison study between a conventional 3D texturing method and the methods of an exemplary embodiment of the present invention;

FIG. 31 is a graph depicting the results of a second rendering time comparison study between a conventional 3D texturing method and the methods of an exemplary embodiment of the present invention;

FIG. 32 is a graph depicting the results of a third rendering time comparison study between a conventional 3D texturing method and the methods of an exemplary embodiment of the present invention;

FIG. 33 is a graph depicting the results of a transfer time comparison between a conventional 3D texturing method and the methods of an exemplary embodiment of the present invention;

FIG. 34 is a graph depicting the results of a second transfer time comparison between a conventional 3D texturing method and the methods of an exemplary embodiment of the present invention;

FIG. 35 is an exemplary process flow diagram for an exemplary volume creation algorithm for ultrasound images acquired in a freehand manner;

FIG. 36 is an exemplary image of an exemplary carotid artery acquired using the exemplary method illustrated in FIG. 35;

FIGS. 37 through 42 illustrate various processes in the exemplary algorithm illustrated in FIG. 35; and

FIG. 43 is an exemplary process flow diagram illustrating an exemplary slice reduction optimization which is an optional process in the exemplary algorithm presented in FIG. 35.

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

In exemplary embodiments of the present invention, 2D ultrasound acquired planes with known 3D positions can be directly mapped into corresponding 2D planes, and then displayed back to front towards a user's viewpoint. In exemplary embodiments of the present invention this can produce, for example, a 3D projection in real time identical to that obtained from conventional volume rendering, without the need for specialized graphics hardware, resampling or having to reduce the resolution of acquired volume data to maintain substantially real-time displays.

Because in exemplary embodiments according to the present invention 4D images can be, for example, displayed in substantially real-time relative to their acquisition, the images can be, for example, available to a user while he or she carries out a dynamic ultrasound examination. Thus, a user can be presented with real-time depth perception of areas of interest that can be continually updated as the user dynamically moves an ultrasound probe in various directions through a field of interest.

Thus, in exemplary embodiments of the present invention, a 4D image can be generated that appears like a conventionally reconstructed one, without the need for 3D resampling and filtering. Moreover, to remove noise and smooth the image 2D filters can be used, which are much less expensive than the 3D filters which must be used in conventional volumetric reconstruction.

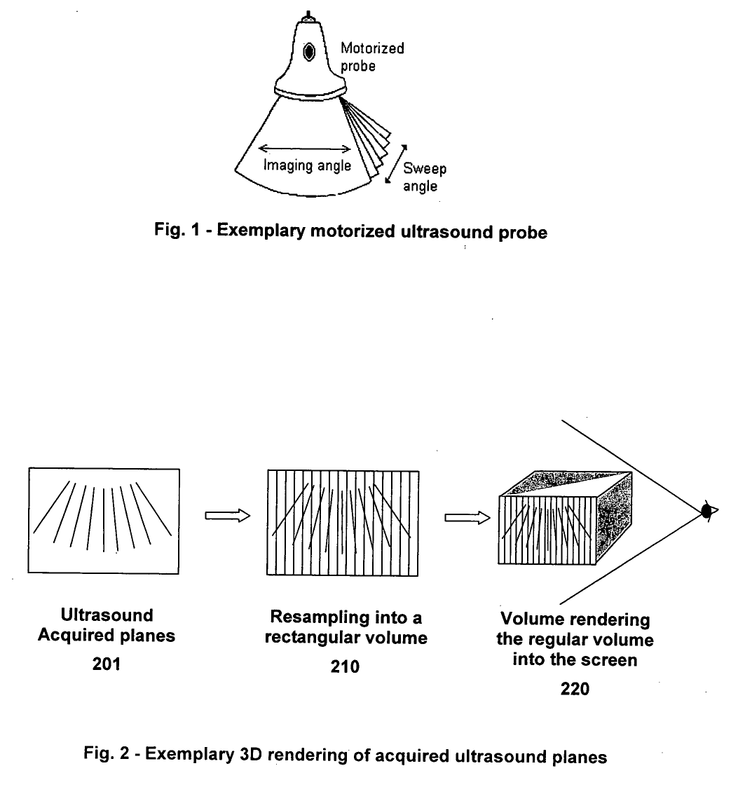

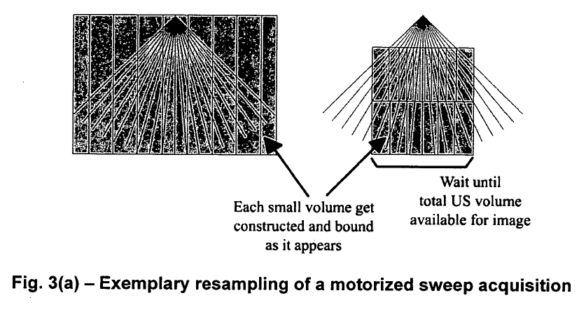

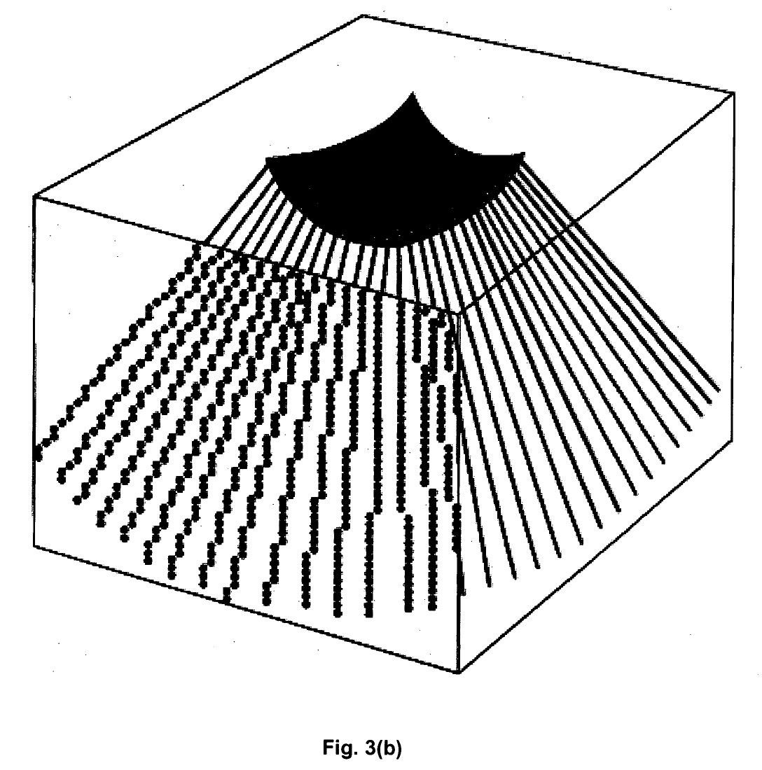

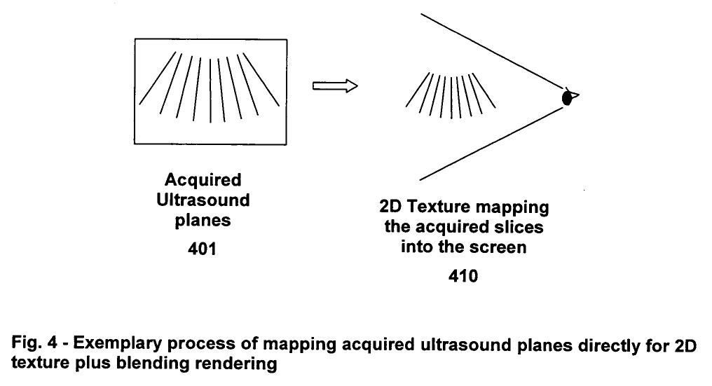

In exemplary embodiments of the present invention, a set of 2D ultrasound acquisitions can be, for example, made for an area of interest using a probe, as is illustrated in FIG. 4. The probe can be, for example, a motorized ultrasound probe as is shown in FIG. 1, a probe with an array of sensors that can be fired line after line in sequence, or any similarly appropriate probe that allows a user to acquire multiple 2D image planes. In exemplary embodiments of the present invention, acquired 2D image planes can, for example, be mapped into 3D space using the positional information associated with each acquired plane. As noted, this information can be obtained from the probe itself, such as for example, the motorized probe of FIG. 1, or determined by tracking a probe using a tracking system. Once spatially oriented the image planes can be blended and rendered towards a useful user viewpoint. As is known in the art, blending is combining two values into a final one, using weighted summation. For example with two values (voxels) A and B, and two weights Wa and Wb, a new voxel C=A*Wa+B*Wb can be generated. Exemplary blending functions are discussed in the UltraSonar patent application referenced above.

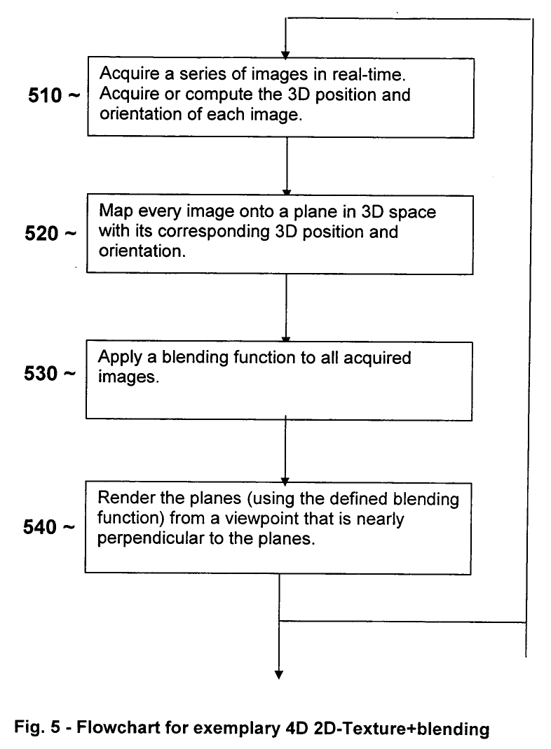

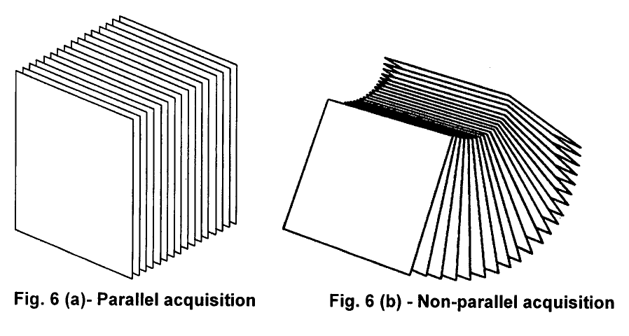

An exemplary process flow for creating a 4D image according to an exemplary embodiment of the present invention is illustrated in FIG. 5. With reference to FIG. 5, at 510, for example, an ultrasound imaging system can, for example, acquire a series of image planes in real-time, and acquire and/or compute the position and orientation of each image. Such acquisition can be performed, for example, by a motorized probe such as is depicted in FIG. 1, or via a similar sensor device which can be coupled to the ultrasound imaging system hardware. The shape and/or sensor characteristics of available probes can vary, and it can be desirable to use a particular shape of probe or a probe with a particular sensor arrangement based on the ultrasound examination to be performed. The most common probes are LINEAR ARRAY and CONVEX ARRAY probes, but there are also many others, such as, for example, ANNULAR. Different sizes can be used to apply them to either the outside of the body or to an inner portion (ENDOSCOPIC). ENDOSCOPIC probes are thus inserted into body cavities (e.g., transrectal, or transesophagal).

As noted, in exemplary embodiments of the present invention, an ultrasound probe can, for example, continuously acquire 2D images in real-time where every image has a known three-dimensional position and orientation. Such positional information can, for example, be acquired through a 3D tracker which tracks the probe, be derived directly from the probe mechanisms, or can be obtained from some other suitable method. The 2D images can, for example, be acquired in such a way that each pair of adjacent images is almost parallel, such as is illustrated in FIG. 6(a), or they can, for example, be acquired in a non-parallel acquisition, as is depicted in FIG. 6(b). FIGS. 6(a) and 6(b) merely provide two examples of acquisitions. In general, the amount of parallelism between the acquired planes can vary based on the type of probe used, the probe's sensor arrangement, the size of the surface area of interest to be imaged, and other similar factors. After a predefined nth slice is acquired, the acquisition system can, for example, continues in a loop by acquiring the first slice again.

At 520, for example, the exemplary ultrasound imaging system can map every 2D image into 3D space using the corresponding 3D position and orientation data. By mapping every 2D image onto a plane in 3D space, the 2D images are made ready to be represented as a three dimensional planar images, i.e., ready to be processed by the 2D texture mapping and blending process described below. The mapping can be performed by “pasting” (i.e., performing 2D texturing) the image onto a plane in a virtual 3D space. If lesser data is desired, or would be redundant, in alternate exemplary embodiments some of the 2D images can be discarded prior to the pasting process.

At 530, for example, a blending function can be applied to each image plane that has been mapped into virtual 3D space. For example, a transparency value can be a type of blending function, where each pixel in the image can have an opacity value. Transparency can be implemented by adding a pixel's intensity value multiplied by an opacity factor to an underlying pixel value. The blending function can be applied from the back plane to the front plane of parallel or non-parallel image planes (for example, as shown in FIGS. 6(a) and 6(b)).

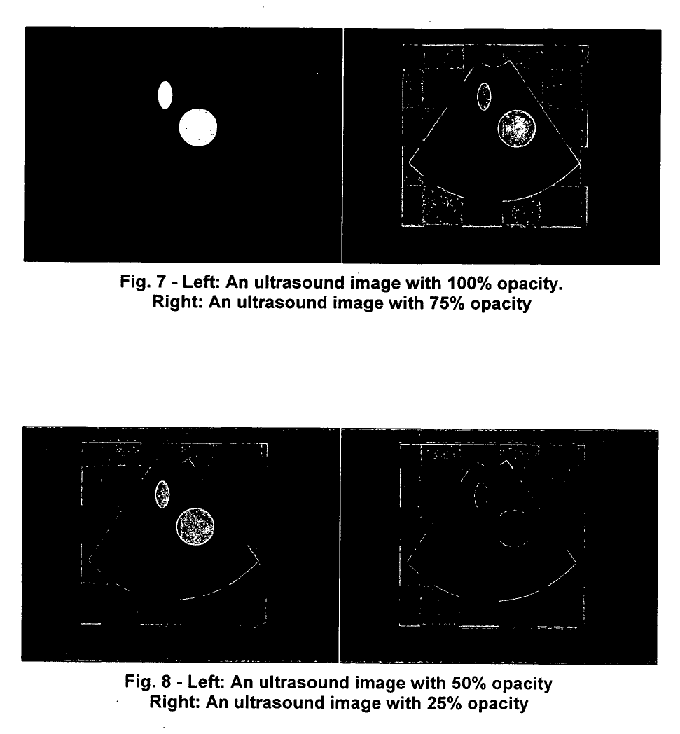

The effect of assigning a single opacity value to every pixel in an image is illustrated in FIGS. 7 and 8. Ultrasound images in FIG. 7 illustrate varying the opacity of an image from 100% opacity to 75% opacity, while FIG. 8 shows ultrasound images with 50% opacity and 25% opacity. Thus, FIGS. 7 and 8 show a decreasing opacity of the image (and thus increasing transparency) such that the background is more and more visible in the combined image.

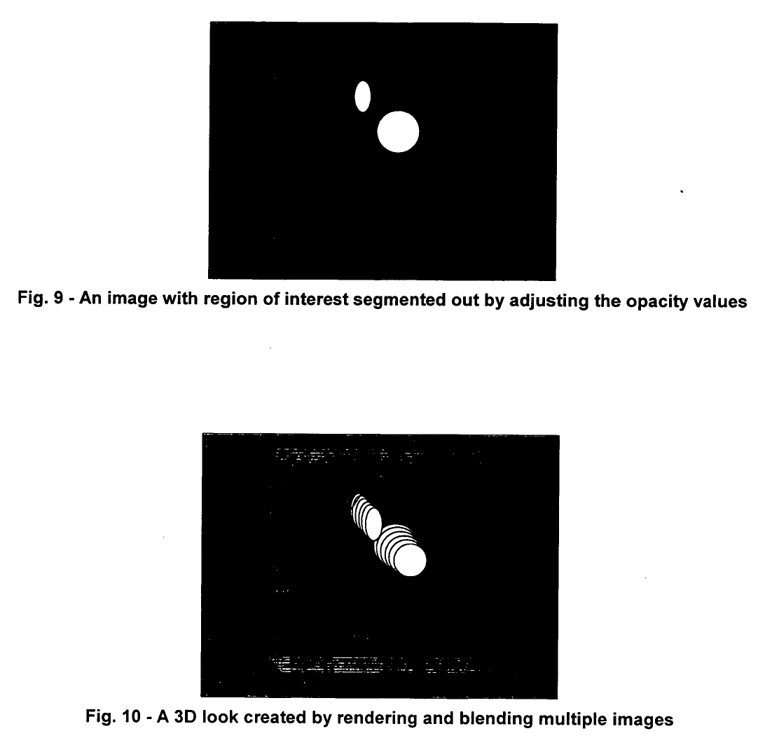

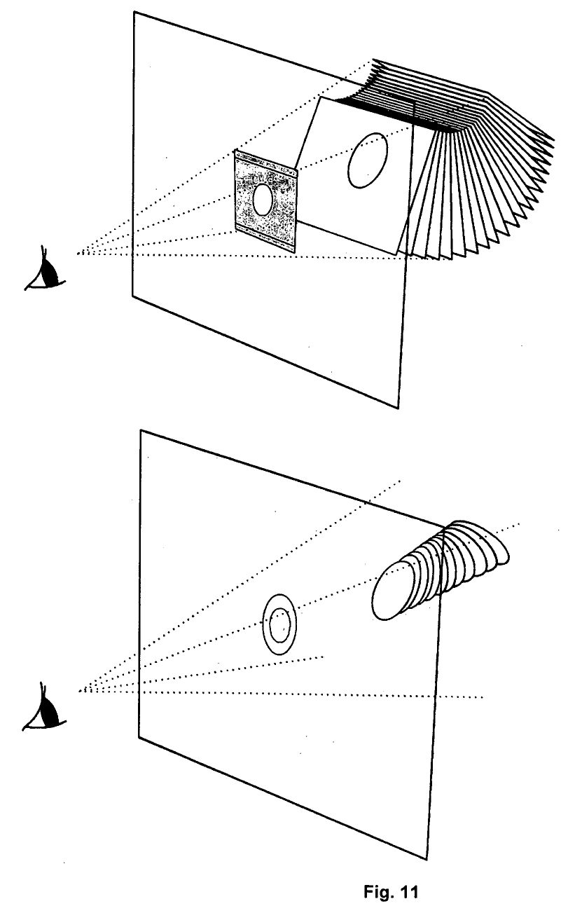

In exemplary embodiments of the present invention, instead of applying a single opacity to an entire image, it can be more desirable, for example, to assign a different opacity value with respect to the pixel intensities. By doing so, desirable intensities can become more prominent and the undesirable intensities are filtered out. One can, for example, differentiate between a “desirable” and an “undesirable” intensity manually, by using defaults, or via image processing techniques. Sometimes, for example, the interesting part of an image can be black (e.g., a vessel without contrast), and sometimes it can be, for example, white (e.g., a vessel with contrast). This technique allows regions of interest to be segmented out, for example, based on their intensity values. An example of this is illustrated in FIG. 9.

Rendering and blending multiple image planes as described above can produce an image with a 3D appearance. An exemplary blended and rendered image is illustrated in FIG. 10. Thus, continuing with reference to FIG. 5, at 540, for example, a blending function can be applied to the 2D images and the images can be displayed in a virtual 3D space. As depicted in FIG. 11, the viewpoint of the display can be set so that it is more or less perpendicular to the planes (i.e., parallel to the scan direction), although different data sets will have a range of acceptable viewpoints +/− X degrees from the vertical to the planes. (Mathematically, a viewpoint set perpendicular to the image planes means, for example, that the viewpoint vector make an angle of nearly zero degree with the normals to the planes). The images can be rendered from back to front. The cumulative effect of blending and rendering the images produces a three dimensional appearance, such as is illustrated in FIGS. 10 and 11. It is noted that this 3D appearance comes without the temporal and image quality price that resampling, 3D filtering and rendering impose.

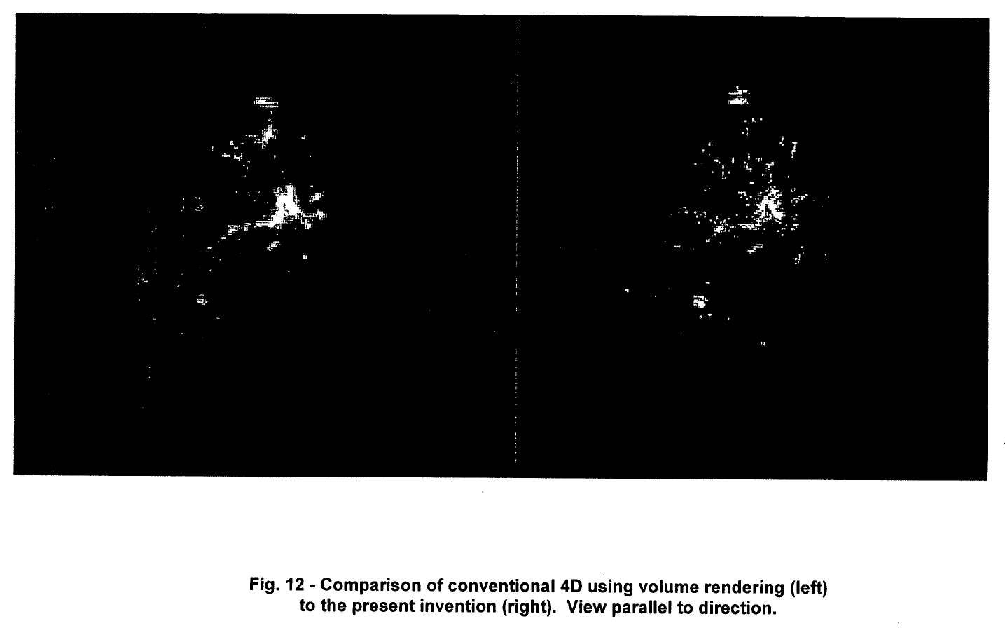

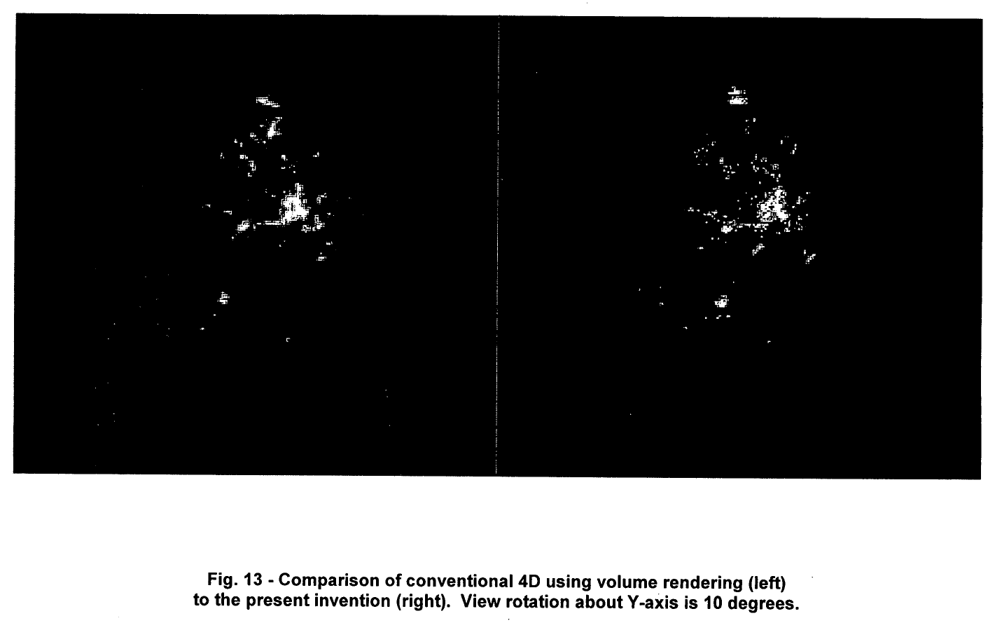

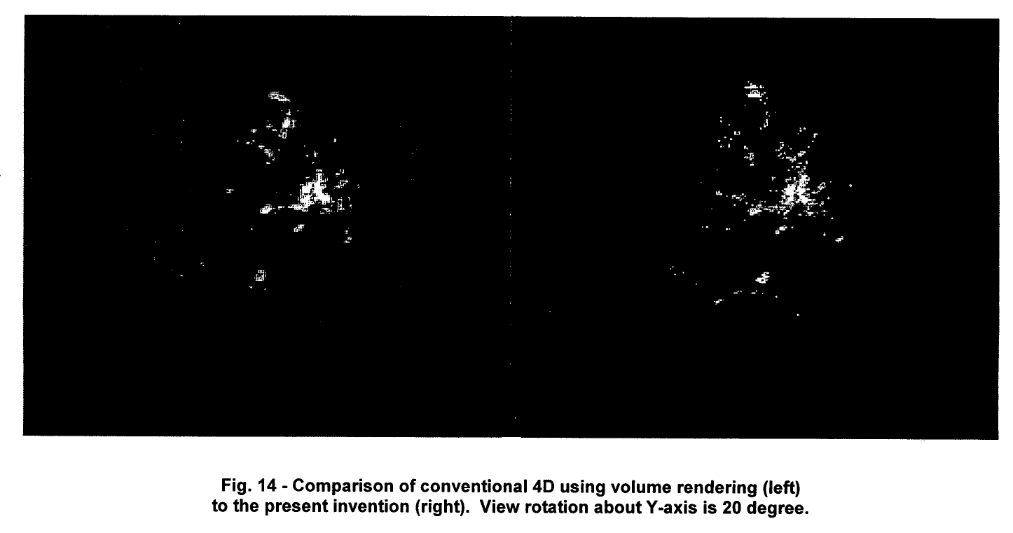

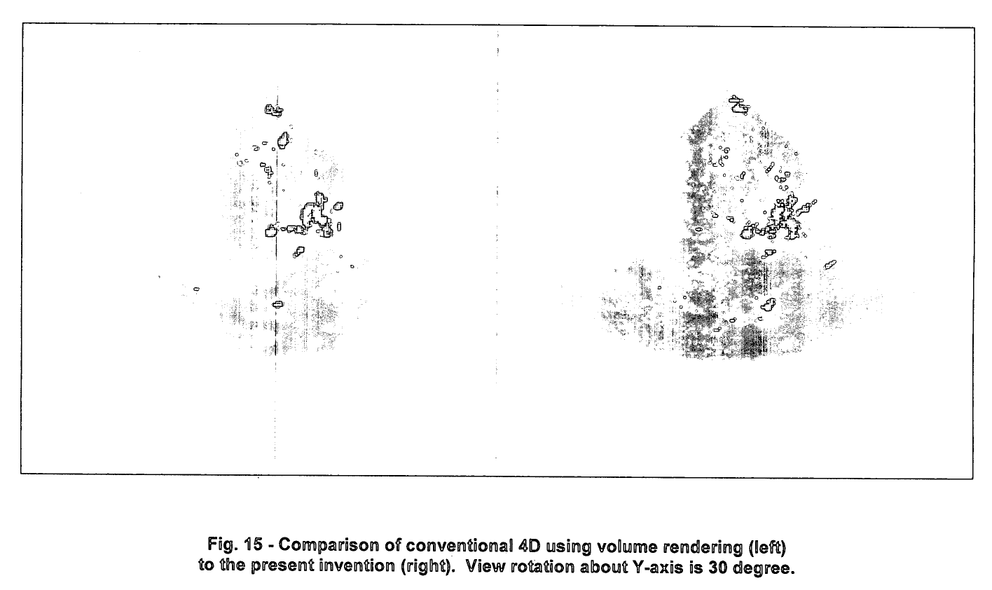

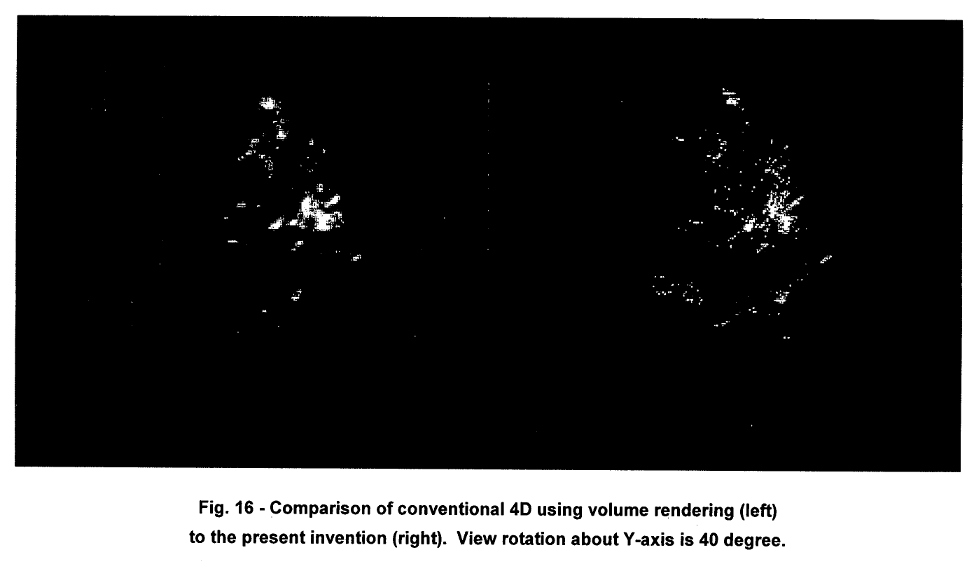

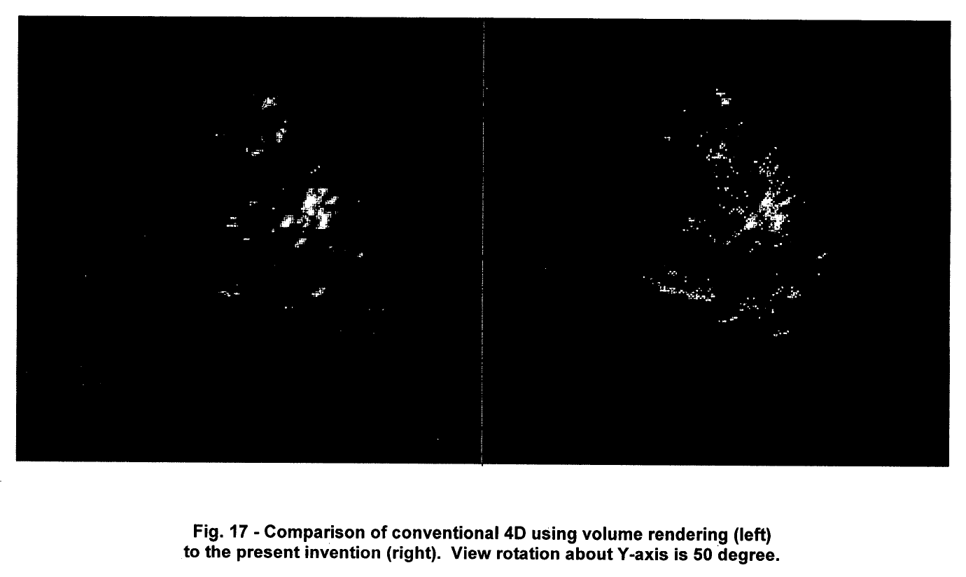

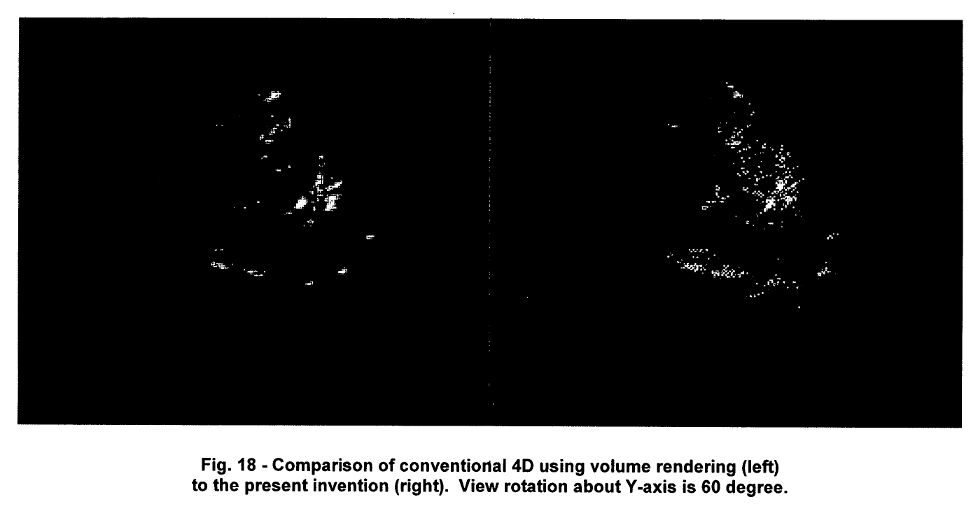

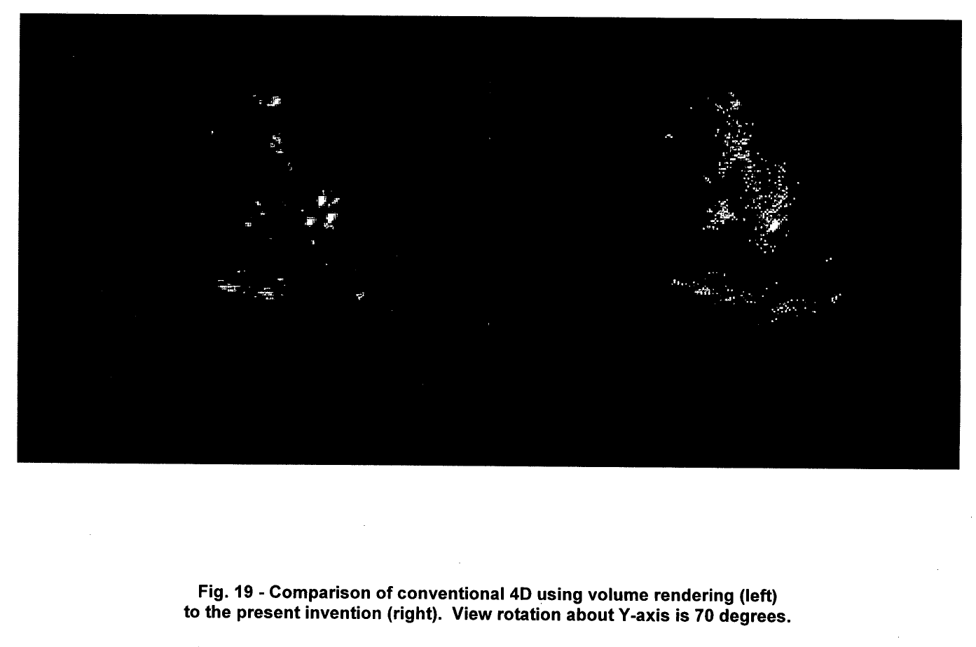

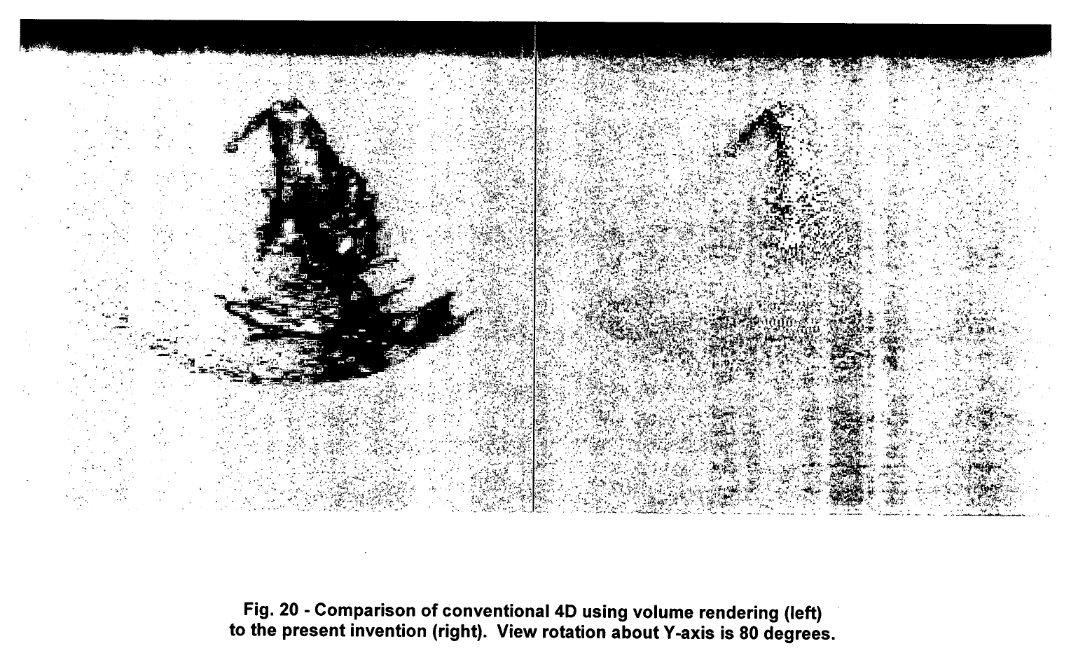

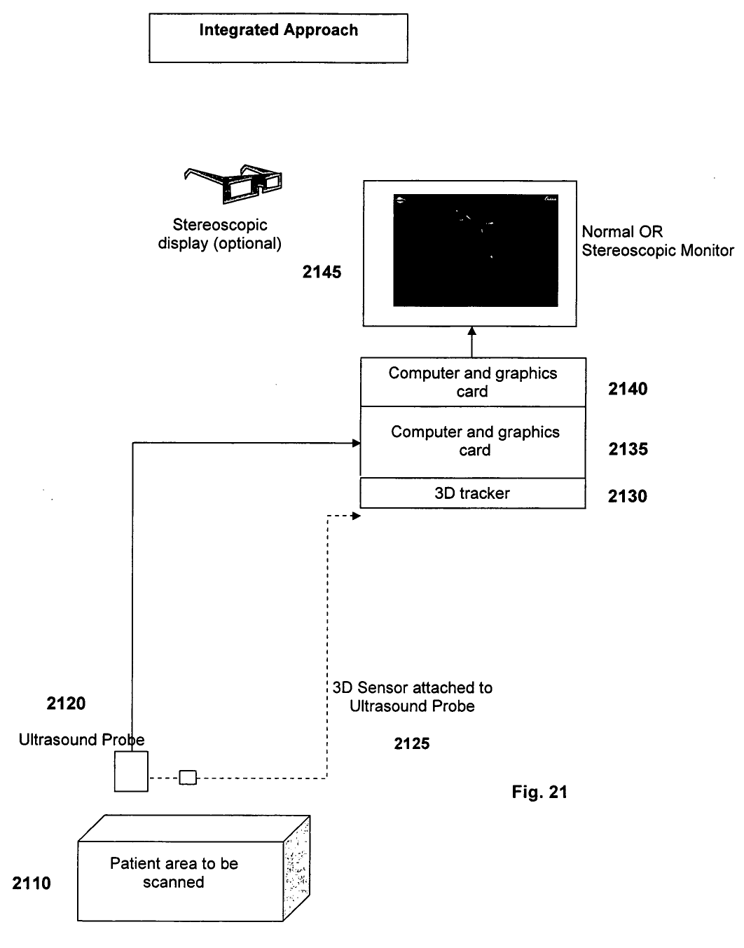

FIGS. 12-20 illustrate a comparison between conventional 4D imaging using lowered resolution of acquired scan planes and conventional resampling and volume rendering (leftmost images in FIGS. 12-20), and images produced using exemplary embodiments of the present invention as described above (rightmost images in FIGS. 12-20). In these figures, the view angle is rotated about the Y-axis (the Y axis is up-down with respect to the screen), ranging from having the viewpoint of the ultrasound images parallel to the sweep direction in FIG. 12, to 80 degrees off of the sweep direction in FIG. 20. As the view angle about the Y-axis from the sweep direction increases, less detail of the image is available. The change in image detail as a function of the view angle relative to the sweep angle is the tradeoff of methods according to the present invention. Thus, at certain viewing angles (i.e., at or within some angle parallel to the sweep direction (or to the opposite of the sweep direction, thus viewing the object “from behind”) a higher image quality at a significantly lower computing and temporal cost relative to conventional techniques is achieved.

Thus, in exemplary embodiments of the present invention a more detailed composite image with better resolution than what can be produced using conventional volume rendering methods can be obtained for viewpoints within a certain range of rotation about the Y-axis from the normal (i.e., either normal—out of the screen or into it in FIG. 12; this is described in greater detail below) to the scan planes. In exemplary embodiments of the present invention an acceptable range of rotation before the image degrades and is not useful can be, for example, 60 degrees. In general the acceptable range of rotation of the viewpoint is domain specific.

One advantage of systems and methods according to exemplary embodiments of the present invention is that they do not require resampling in order to produce a 3D effect, which thus allows for more information to be used to render the image. Another advantage is that less graphics processing power and memory are required in order to render the image than traditional volume rendering techniques. However, there may be instances, for example, in a medical ultrasound examination where an ultrasound imaging system operator would want to be able to view an acquired sample area from various viewpoints, some of which may be beyond the range of acceptable viewing angles available in exemplary embodiments of the present invention. In such an instance, an operator can select an option on the ultrasound imaging system to switch from acquisitions using the techniques of the present invention to traditional 3D volume rendering methods and back again.

Additionally, exemplary embodiments of the present invention can be implemented as one of the tools available to a user in the methods and systems described in the SonoDEX patent application referenced above.

In exemplary embodiments according to the present invention, a volumetric ultrasound display can be presented to a user by means of a stereoscopic display that further enhances his or her depth perception.

Exemplary Systems

In exemplary embodiments according to the present invention, an exemplary system can comprise, for example, the following functional components:

An ultrasound image acquisition system;

A 3D tracker; and

A computer system with graphics capabilities, to process an ultrasound image by combining it with the information provided by the tracker.

An exemplary system according to the present invention can take as input, for example, an analog video signal coming from an ultrasound scanner. A standard ultrasound machine generates an ultrasound image and can feed it to a separate computer which can then implement an exemplary embodiment of the present invention. A system can then, for example, produce as an output a 1024×768 VGA signal, or such other available resolution as can be desirable, which can be fed to a computer monitor for display. Alternatively, as noted below, an exemplary system can take as input a digital ultrasound signal.

Systems according to exemplary embodiments of the present invention can work either in monoscopic or stereoscopic modes, according to known techniques. In preferred exemplary embodiments according to the present invention, stereoscopy can be utilized inasmuch as it can significantly enhance the human understanding of images generated by this technique. This is due to the fact that stereoscopy can provide a fast and unequivocal way to discriminate depth.

Integration into Commercial Ultrasound Scanners

In exemplary embodiments according to the present invention, two options can be used to integrate systems implementing an exemplary embodiment of the present invention with existing ultrasound scanners:

Fully integrate functionality according to the present invention within an ultrasound scanner; or

Use an external box.

Each of these options are described below.

Full Integration Option

FIG. 21 illustrates an exemplary system of this type. In an exemplary fully integrated approach, ultrasound image acquisition equipment 2101, a 3D tracker 2102 and a computer with graphics card 2103 can be wholly integrated. In terms of real hardware, on a scanner such as, for example, the Technos MPX from Esaote S.p.A. (Genoa, Italy), full integration can easily be achieved, since such a scanner already provides most of the components required, except for a graphics card that supports the real-time blending of images. Optionally, any stereoscopic display technique can be used, such as autostereoscopic displays, or anaglyphic red-green display techniques, using known techniques. A video grabber is also optional, and is in some exemplary embodiments can be undesired, since it would be best to provide as input to an exemplary system an original digital ultrasound signal. However, in other exemplary embodiments of the present invention it can be economical to use an analog signal since that is what is generally available in existing ultrasound systems. A fully integrated approach can take full advantage of a digital ultrasound signal.

External Box Option

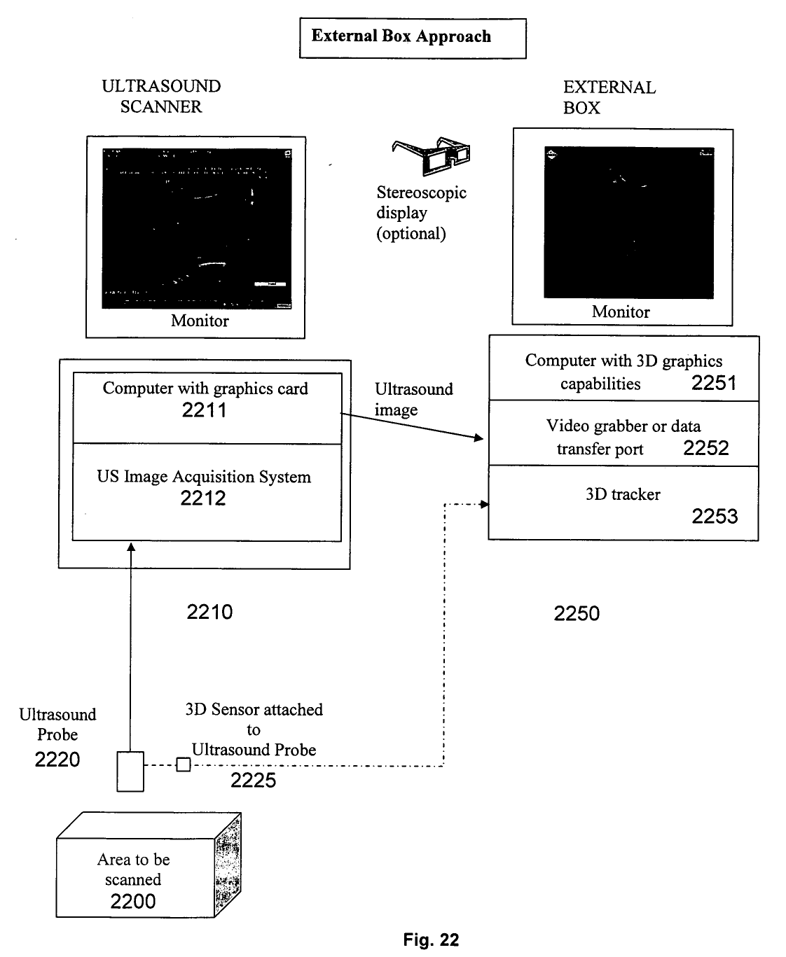

FIG. 22 illustrates an exemplary system of this type. This approach can utilize a box external to the ultrasound scanner that takes as an input the ultrasound image (either as a standard video signal or as a digital image), and provides as an output a 3D display. Such an external box can comprise a computer with 3D graphics capabilities 2251, a video grabber or data transfer port 2252 and can have a 3D tracker to track the position and orientation in 3D of a sensor 2225 connected to an ultrasound probe 2220. Such an external box can, for example, connect through a video analog signal. As noted, this may not be an ideal solution, since scanner information such as, for example, depth, focus, etc., would have to be obtained by image processing on the text displayed in the video signal. Such processing can have to be customized for each scanner model, and can be subject to modifications in the user interface of the scanner. A better approach, for example, is to obtain this information via a data digital link, such as, for example, a USB port, or a network port. An external box can be, for example, a computer with two PCI slots, one for the video grabber 2252 (or a data transfer port capable of accepting the ultrasound digital image) and another for the 3D tracker 2253.

It is noted that in the case of the external box approach it is important that there be no interference between the manner of displaying stereo and the normal clinical environment of the user. There will be a main monitor of the ultrasound scanner as well as that on the external box. If the stereo approach of the external box monitor (where the 4D image is displayed) uses shutter glasses, the different refresh rates of the two monitors can produce visual artifacts (blinking out of sync) that may be annoying to the user. Thus, in the external box approach the present invention can be used, for example, with a polarized stereoscopic screen (so that a user wears polarized glasses that will not interfere with the ultrasound scanner monitor; and additionally, will be lighter and will take away less light from the other parts of the environment, especially the patient). An even better approach is to use autostereoscopic displays, so that no glasses are required.

Further details on exemplary systems in which methods of the present invention can be implemented are discussed in the UltraSonar and SonoDEX patent applications described above. The methods of the present invention can be combined with either of those technologies to offer users a variety of integrated imaging tools and techniques.

Exemplary Process Flow Illustrated

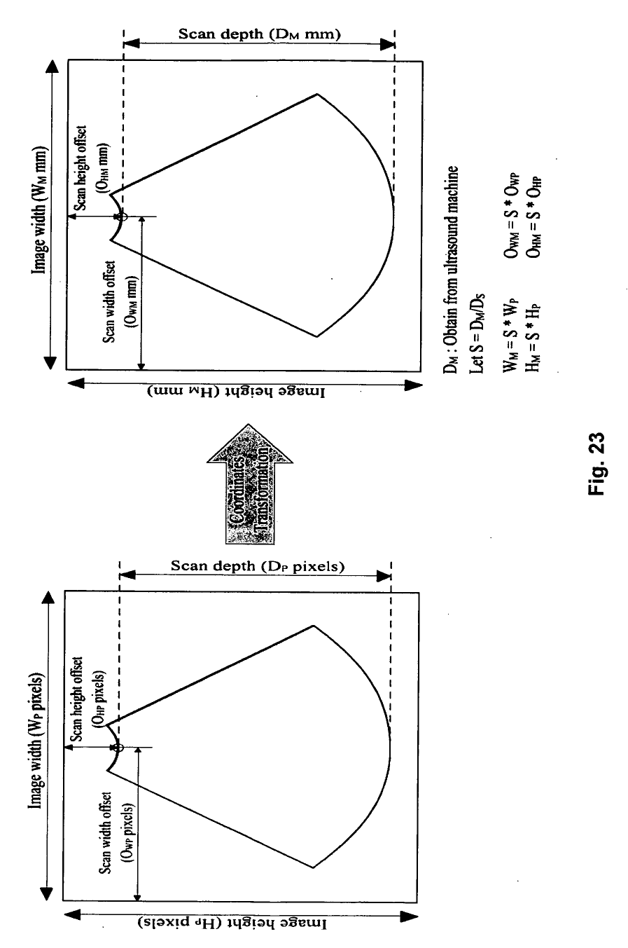

In exemplary embodiments of the present invention, the following exemplary process, as illustrated in FIGS. 23-26, can be implemented, as next described.

1. When a 2D image is acquired, it has a width and height in pixels. There is a scan offset that denotes the offset of the center of the acquisition. The scan offset has, for example, a height and width offset as its components, as shown in FIG. 23.

2. By knowing the depth information from the ultrasound machine, the dimensions of the image in pixels can, for example, be transformed into virtual world dimensions of mm or cm, also as shown in FIG. 23.

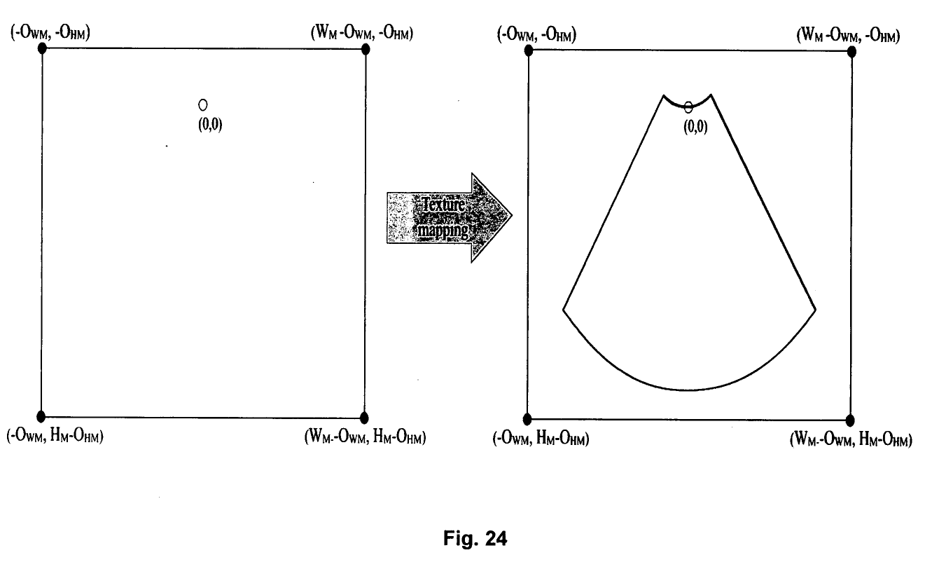

3. A polygon can, for example, be created in the virtual world dimension using the center of the image acquisition as its origin. A texture map of the acquired image can then be mapped onto this polygon, as shown in FIG. 24.

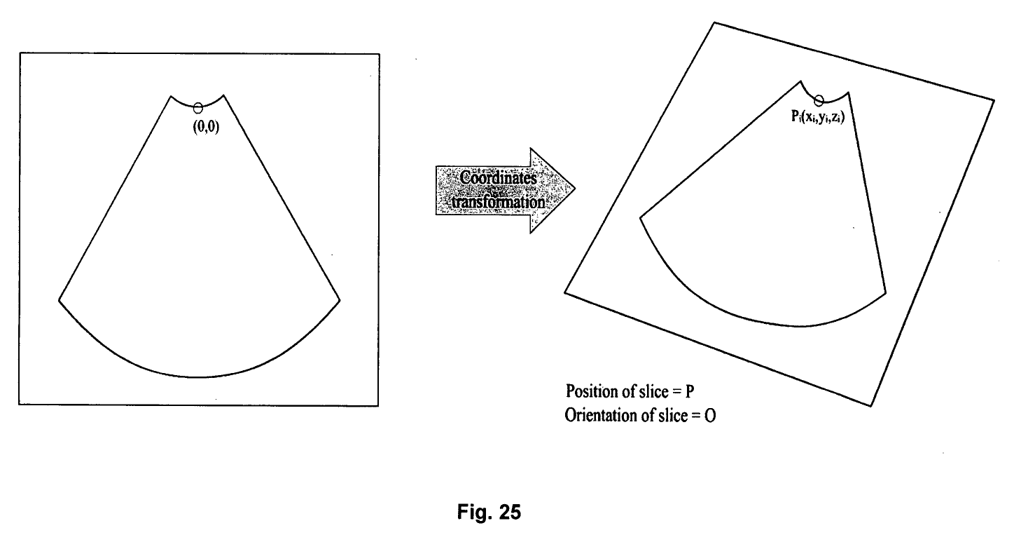

4. The textured polygon, can, for example, be transformed into the virtual world coordinates system based upon its position and orientation (as, for example, acquired from the scanner or 3D tracking device). This is illustrated in FIG. 25.

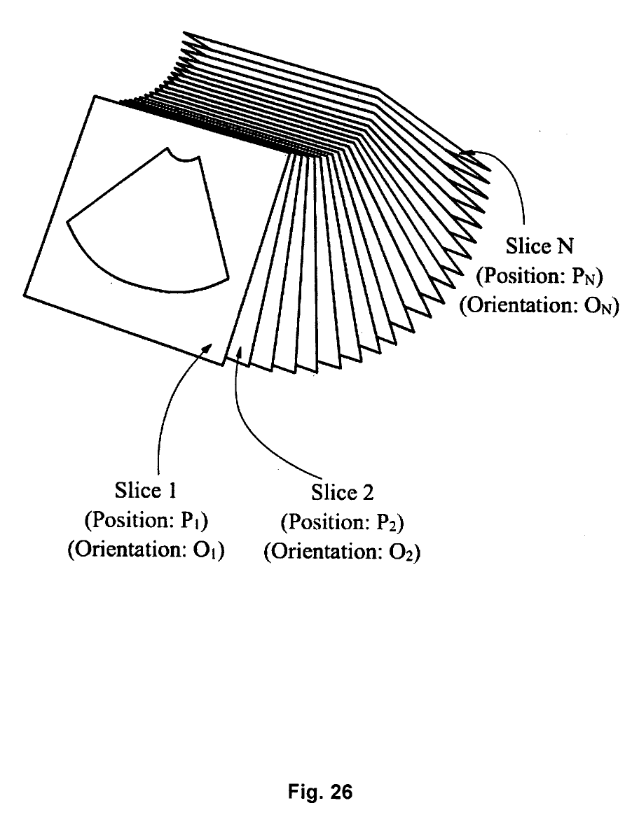

5. Multiple image slices can acquired and transformed (i.e., steps 1 to 4 above), each having a particular position and orientation, as shown in FIG. 26.

6. When a pre-determined number N of slices are acquired, the slices can be, for example, sorted according to the viewing z-direction. If slice N is in front, then the sorting can be, for example, in descending order (slice N, slice N−1, . . . , slice 1), otherwise, for example, it can be in ascending order (slice 1, slice 2, . . . , slice N).

7. The slices can then, for example, be rendered in their sorting order (i.e., either from 1 to N, or from N to 1, as the case may be depending upon the viewpoint), and the blending effect applies as each slice is rendered.

The process can repeat sub-processes 1 through 6 above at a high speed to create a 4D effect.

Results of Experimental Comparison of Present Invention with Conventional 3D Ultrasound

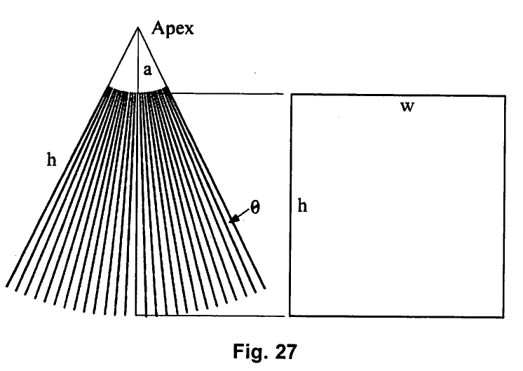

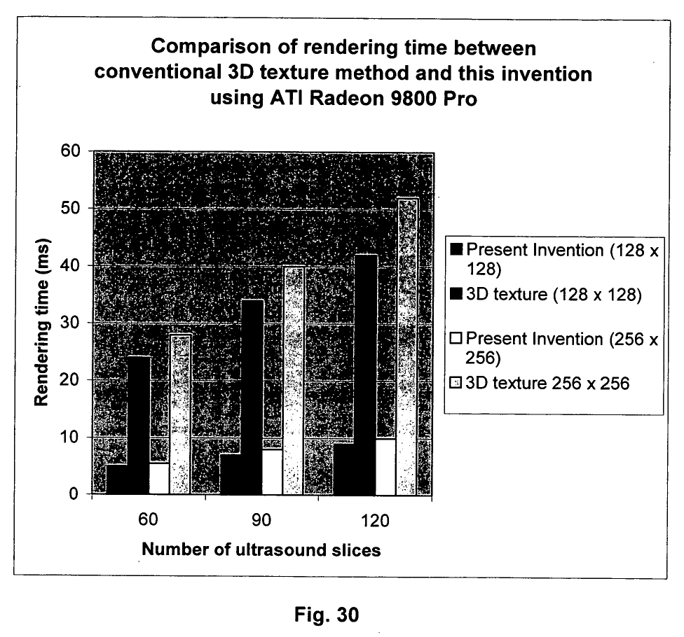

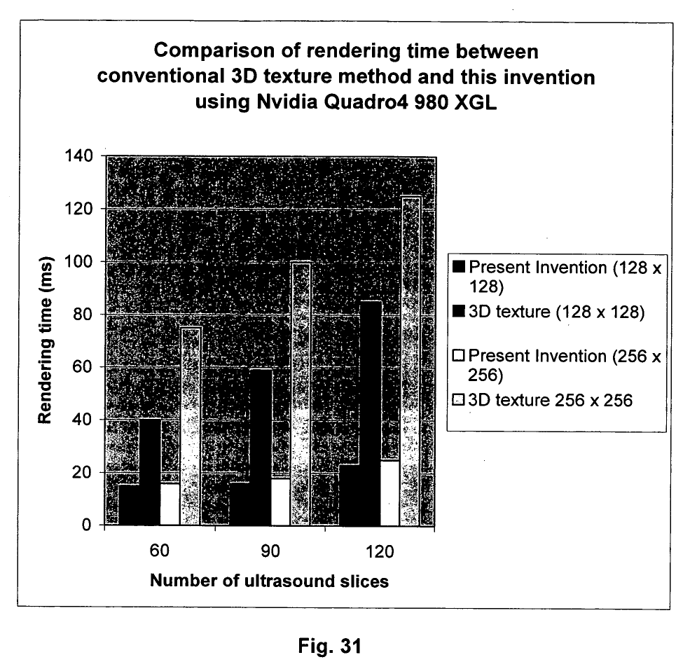

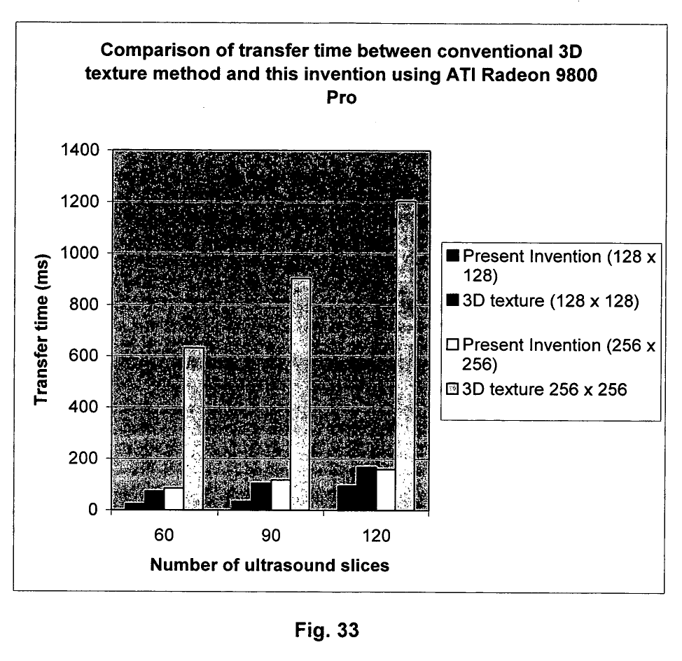

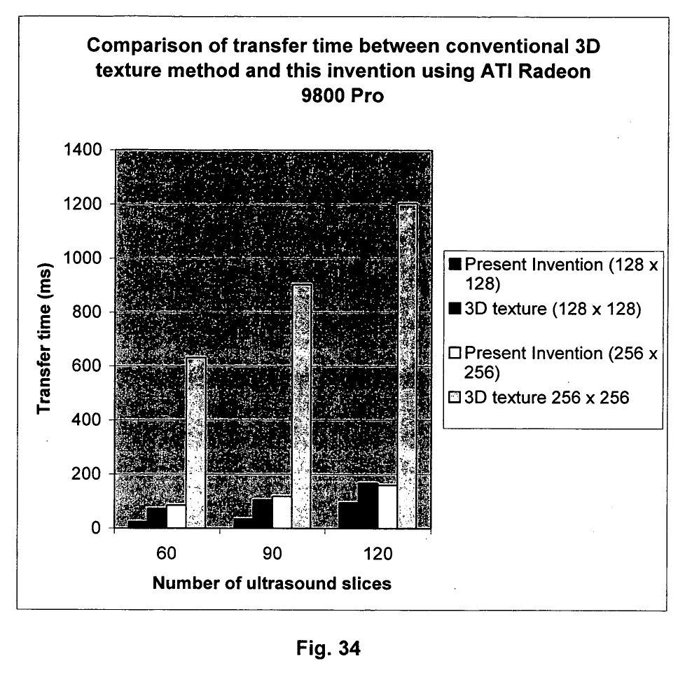

FIGS. 27 through 34 illustrate the temporal efficiencies of exemplary embodiments of the present invention relative to conventional 3D ultrasound techniques. The data contained in these figures resulted form experimental runs of the methods of the present invention and of conventional 3D texturing on each of the same three common graphics cards.

Assumptions Used in and Theoretical Basis for Comparisons

FIG. 27 illustrates an exemplary ultrasound image acquisition scenario. Assuming that there are N slices with each pair of adjacent slices making an angle of θ and each slice having a width w and a height h, the amount of information needed (in bytes) l_{A} according to an exemplary embodiment of the present invention is given by the equation:
l_{A}=Nwh

On the other hand, in a typical 4D interpolated volume, the amount of information needed l_{B} is given by the equation:
l_{B}=0.5(N−1)θh(h+2a)

And thus the amount of information that needs to be interpolated is thus l_{B}−l_{A}.

Table A below contains a comparison of l_{A} and l_{B} for various commonly used configurations, assuming that a is 0.2*h, θ is 1° and N is 90.

TABLE A

| Configu- | | | | | | |
|---|---|---|---|---|---|---|
| rations | w | h | a | I_{A}(MB) | I_{B}(MB) | I_{B}− I_{A}(MB) |
| 1 | 128 | 128 | 25.6 | 1.40625 | 2.17468 | 0.76843 |
| 2 | 128 | 256 | 51.2 | 2.8125 | 8.698721 | 5.886221 |
| 3 | 256 | 256 | 51.2 | 5.625 | 17.39744 | 11.77244 |
| 4 | 256 | 512 | 102.4 | 11.25 | 69.58977 | 58.33977 |
| 5 | 512 | 512 | 102.4 | 22.5 | 139.1795 | 116.6795 |

Thus, as seen in Table A, as image resolution doubles, l_{B}-l_{A} increases nearly tenfold.

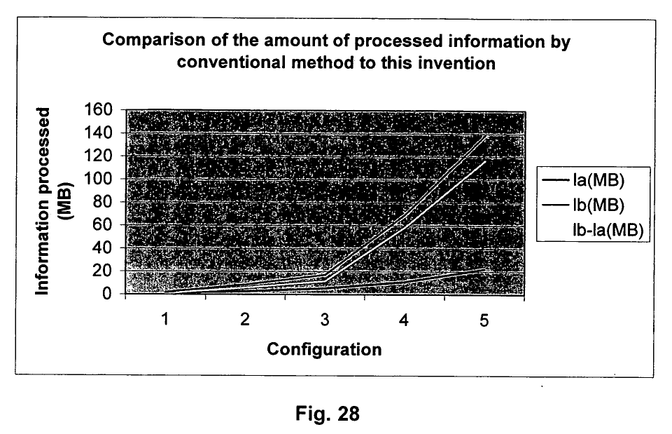

FIG. 28 graphically presents a comparison of the information that is processed by both methods. By using interpolation in the current conventional method, the processing needed increases exponentially as the width and height of the images increase. Exemplary embodiments of the present invention do not have this problem and thus the processing needed increases almost linearly with image resolution.

Thus, as image sizes continue to grow, exemplary embodiments of the present invention can be used, for example, as an add-on to high end ultrasound machines to provide a quick, efficient, and low-processing means to view 3D or 4D volumes, subject to restrictions on the ability to rotate away from the acquisition direction, as for example, a first pass examination, or for example, while the machine is busy processing 3D volumes in the conventional sense.

As image resolutions as well as slice numbers continue to increase, the processing gap between methods according to exemplary embodiments of the present invention and conventional 3D volume rendering of images will only increase, further increasing the value of systems and methods according to exemplary embodiments of the present invention.

Rendering Time Comparisons

Comparison of rendering times between conventional methods and those of exemplary embodimetns of the present invention for various resolutions of the ultrasound slices and various numbers of overall image slices acquired were run.

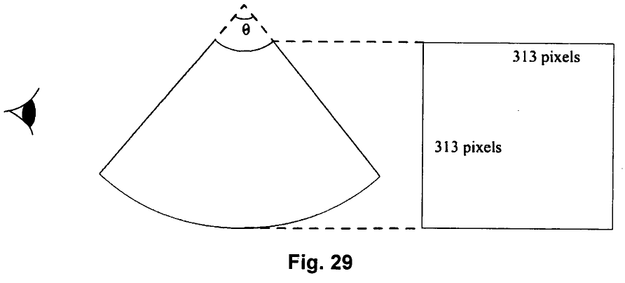

Three different graphics cards were used for this comparison. Various configurations using different numbers of slices were tested, with each pair of adjacent slices making an angle of 1°. For conventional volume rendering, a volume that enclosed the slices tightly was rendered, so that all the information was preserved. The resultant rendered image covered a footprint of 313×313 pixels for each method. This is shown in FIG. 29.

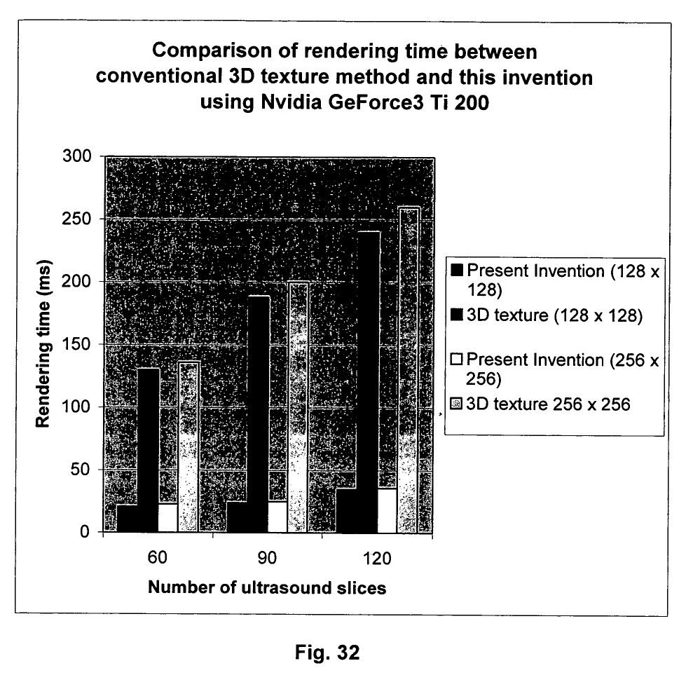

The following Tables B-D, and accompanying graphs in FIGS. 31-32, respectively, show the rendering times of each method with different configurations for three different graphics cards.

TABLE B
Rendering Times (ms) for ATI Radeon 9800 Pro Graphics Card

| | Present | | | |
|---|---|---|---|---|
| Number | Invention | 3D texture | Present Invention | 3D texture |
| of slices | (128 × 128) | (128 × 128) | (256 × 256) | (256 × 256) |
| 60 | 5 | 24 | 5.5 | 28 |
| 90 | 7 | 34 | 8 | 40 |
| 120 | 9 | 42 | 10 | 52 |

TABLE C
Rendering Times (ms) for Nvidia Quadro4 980 XGL Graphics Card

| | Present | | | |
|---|---|---|---|---|
| Number | Invention | 3D texture | Present Invention | 3D texture |
| of slices | (128 × 128) | (128 × 128) | (256 × 256) | (256 × 256) |
| 60 | 15 | 40 | 16 | 75 |
| 90 | 16 | 59 | 18 | 100 |
| 120 | 23 | 85 | 25 | 125 |

TABLE D
Rendering Times (ms) for Nvidia GeForce3 Ti 200 Graphics Card

| | Present | | | |
|---|---|---|---|---|
| Number | Invention | 3D texture | Present Invention | 3D texture |
| of slices | (128 × 128) | (128 × 128) | (256 × 256) | (256 × 256) |
| 60 | 21 | 130 | 23 | 136 |
| 90 | 24 | 188 | 25 | 200 |
| 120 | 35 | 240 | 36 | 260 |

Transfer Time Comparisons

Comparison of transfer time data for conventional method versus exemplary embodiments of the present invention for various resolutions of the ultrasound slices and two different graphics cards were run. In this test the data transfer time from the computer main memory to each graphics card's texture memory was measured. This time, together with the rendering time and the processing time (mentioned above) determines the frame rate for 4D rendering.

Various configurations using different number of slices were tested, with each pair of adjacent slices making an angle of 1°. For conventional volume rendering, as above, a volume that enclosed the slices tightly was rendered, so that all of the information was preserved.

Tables E and F below show the respective transfer times in miliseconds for both methods with different configurations for two different graphics cards. It is noted that unlike the rendering time comparisons described above, transfer time comparisons using the Nvidia GeForce3 Ti 200 graphics card (the slowest of the three used in these tests) were not done because the transfer time for conventional texture rendering on this graphics card is simply too long to be of any practical use.

TABLE E
Transfer Times (in ms) for ATI Radeon 9800 Pro Graphics Card

| | Present | | | |
|---|---|---|---|---|
| Number | Invention | 3D texture | Present Invention | 3D texture |
| of slices | (128 × 128) | (128 × 128) | (256 × 256) | (256 × 256) |
| 60 | 24 | 73 | 85.5 | 632 |
| 90 | 34 | 105 | 118 | 903 |
| 120 | 95 | 168 | 160 | 1204 |

TABLE F
Transfer Times (ms) for Nvidia Quadro4 980 XGL Graphics Card

| | Present | | | |
|---|---|---|---|---|
| Number | Invention | 3D texture | Present Invention | 3D texture |
| of slices | (128 × 128) | (128 × 128) | (256 × 256) | (256 × 256) |
| 60 | 1 | 24 | 1 | 229 |
| 90 | 1 | 36 | 7 | 320 |
| 120 | 2 | 90 | 8 | 465 |

Volumetric Creation Using Freehand Ultrasound Images

Conventional ultrasound systems use a 1D transducer probe (i.e., having one row of transducers as opposed to a matrix of transducers, as in 3D probes) to produce a 2D image in real-time. In exemplary embodiments of the present invention, by attaching a 3D tracking device to such an ultrasound probe, it is possible to generate a 3D volumetric image.

Although conventional volumetric ultrasound imaging is well-established using a 3D/4D ultrasound probe, it is not feasible to use such a probe in smaller areas of the human body such as, for example, when scanning the carotid pulse. This is because 3D probe has a large footprint and cannot fit properly. Thus, the ability to use a normal 1D transducer probe to generate a volumetric image is most useful in such contexts.

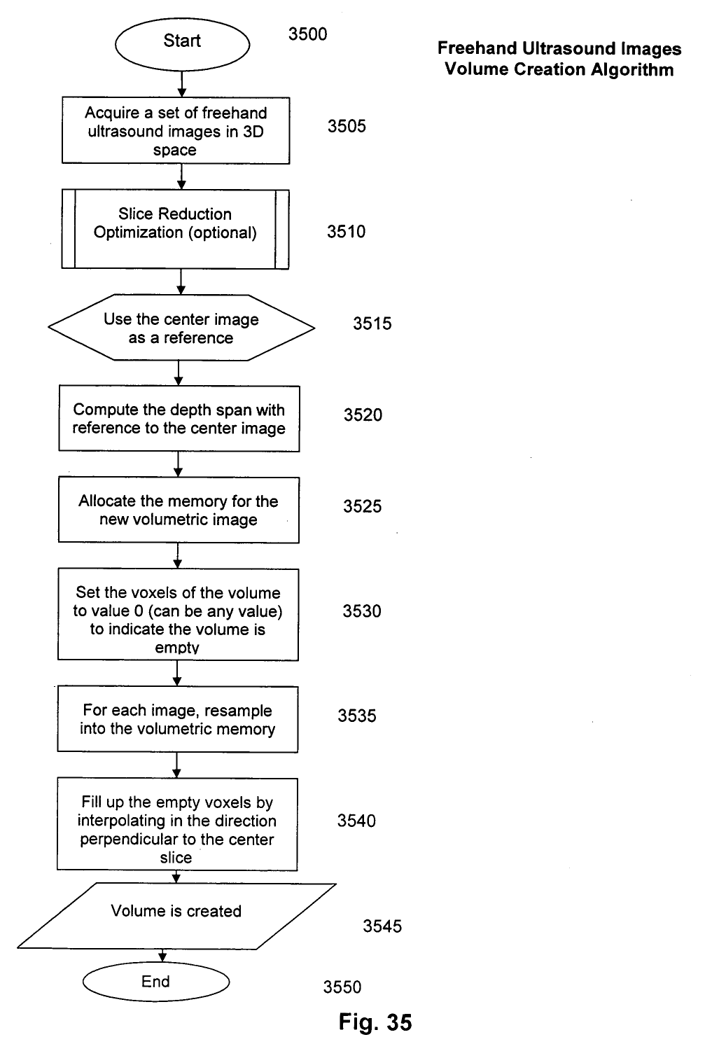

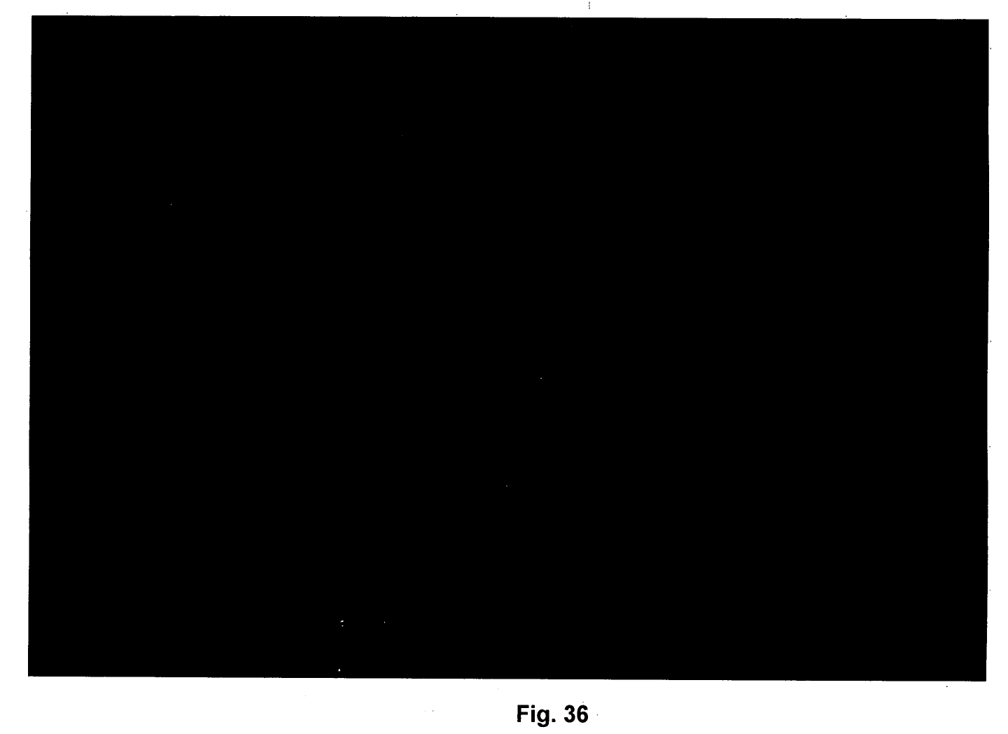

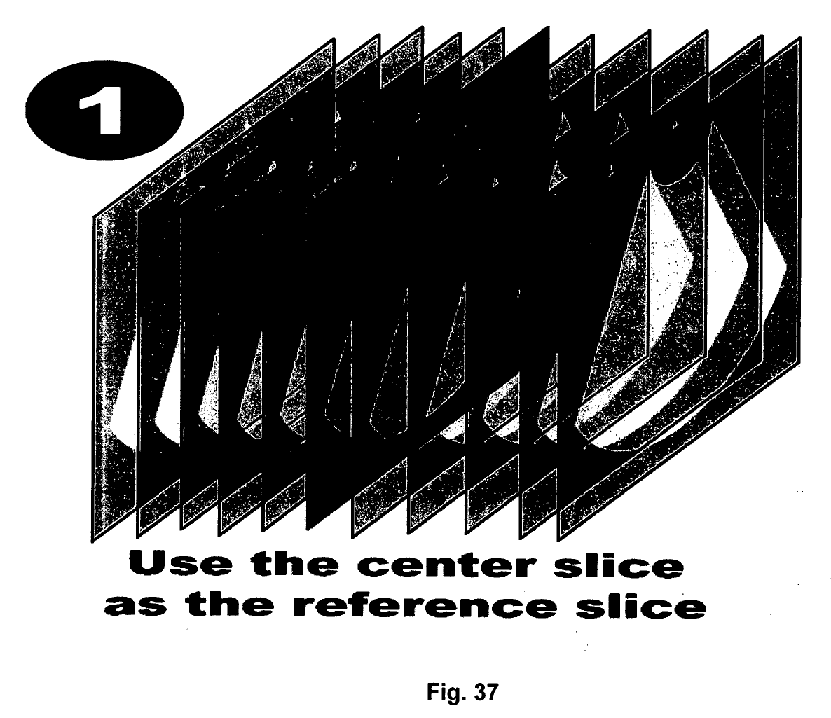

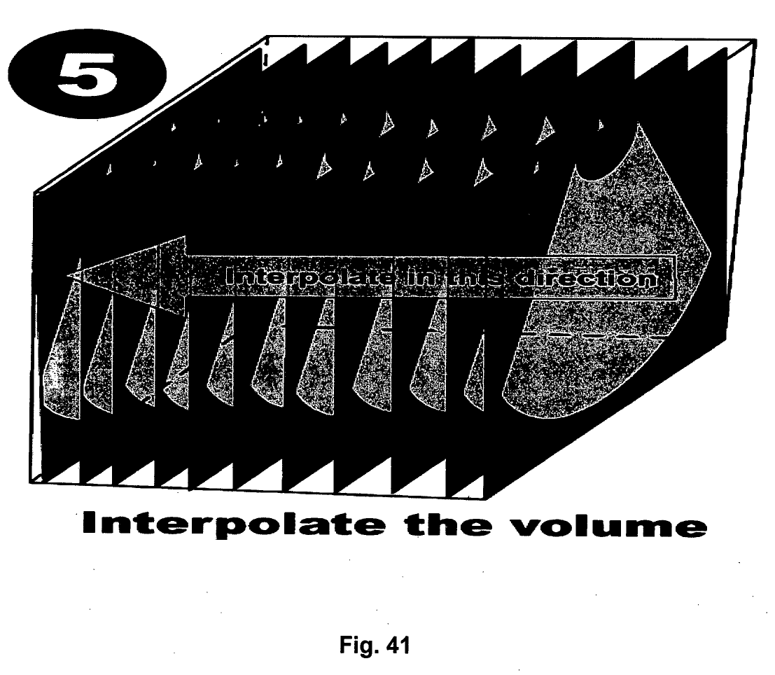

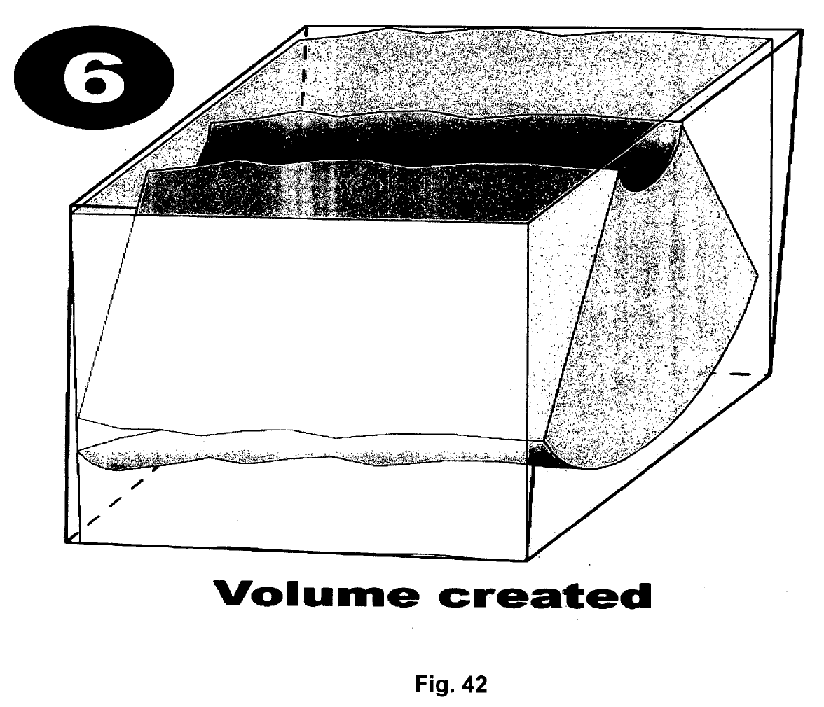

FIG. 35 is an exemplary process flow chart illustrating such a method. FIGS. 37-42 illustrate various exemplary sub-processes of the method, in particular, with reference to FIG. 35, those at 3515 through 3545.

Continuing with reference to FIG. 35, at 3500, a set of 2D images can, for example, be acquired. Each of these images can, for example, have their own respective position and orientation which can be obtained through, for example, an attached 3D tracker on the probe. The positions and orientations of the images are thus not generally arranged in a fixed order as in the case of a 3D/4D ultrasound system, as described above. Thus, the images will in general be arranged as they were when acquired in a freehand manner. At 3510, the number of slices can be reduced via a slice reduction optimization, as described below.

FIGS. 37 through 42 illustrate six successive sub-processes in the exemplary algorithm of FIG. 35. These figures are thus labeled 1-6, beginning with FIG. 37. The six sub-processes are shown as 3515, 3520, 3525, 3530, 3535, and 3540 in the process flow diagram of FIG. 35. With reference thereto, these subprocesses are next described.

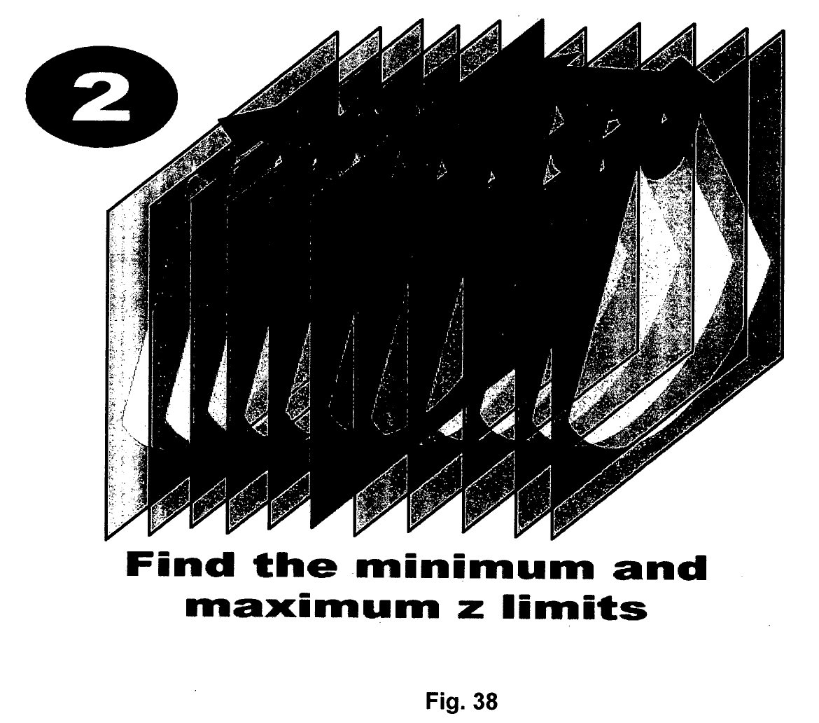

At 3515, the center slice can be used, for example, as a reference slice, as shown in FIG. 37. At 3520, as shown in FIG. 38, the minimum and maximum limits with respect to (i.e., away from in the scan and anti-scan directions) the center slice can, for example, be obtained. This can be done, for example, to compute the resultant bounding box that can, for example, approximately enclose the entire set of images where the reference slice is perpendicular to four sides of the bounding box.

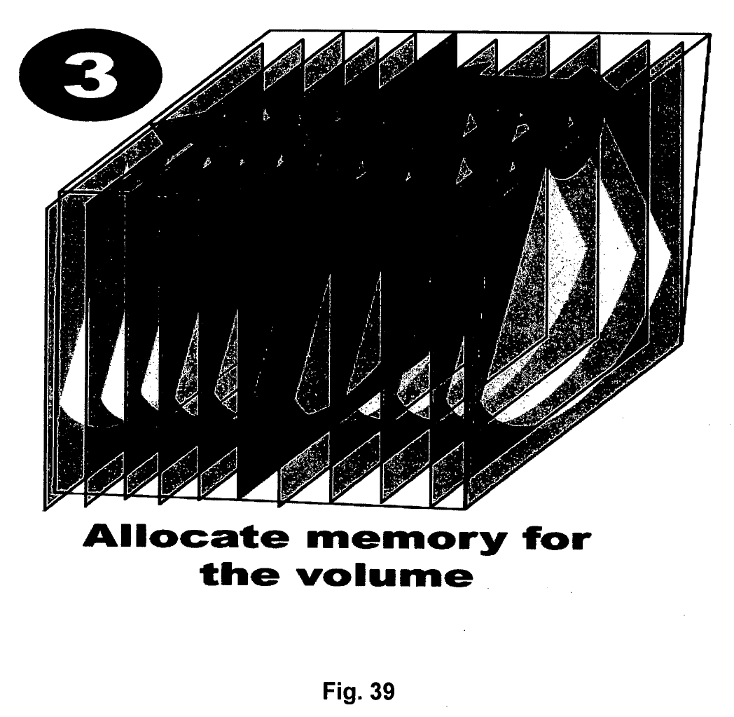

At 3525, as shown in FIG. 39, memory can be allocated for the bounding box. The amount of memory can be used, for example, to decide the detail level of the resulting volume to be created. More memory will allow more information to be re-sampled at 3535. At 3530, for example, this memory can be filled with a value (in this example a “0”) to represent emptiness.

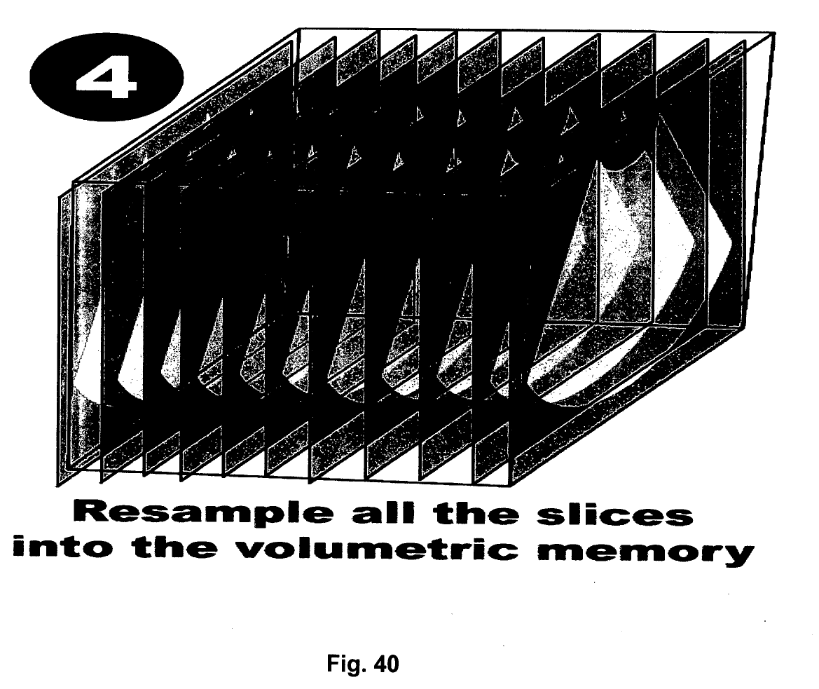

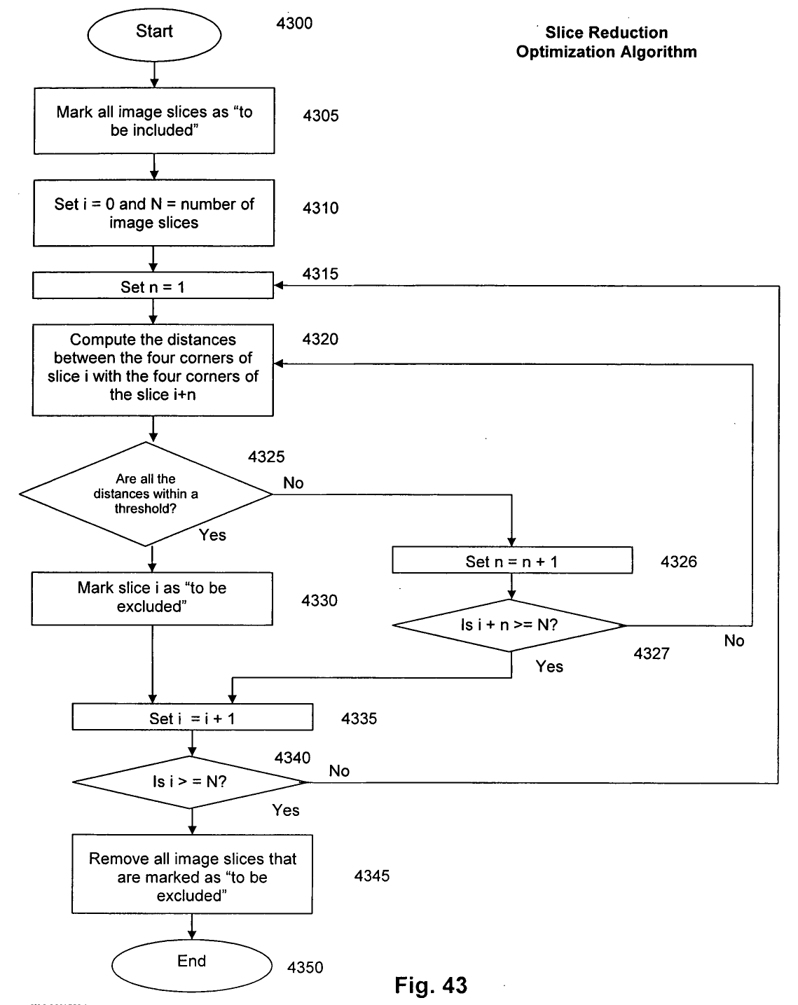

At 3535, as shown in FIG. 40, all the slices can then be re-sampled into the allocated memory. If a value in the slice is equal to the “emptiness” value, then it can be changed to the closed “filled value” (in this example, a “1”). The efficiency of this step can be improved by disregarding slices that are very close to one another in term of position and orientation. This can be done, for example, as is described in connection with the process illustrated in FIG. 43.

At 3540, after re-sampling, empty voxels can be filled up by interpolating in the direction perpendicular to the center slice. Thus, for example, an “empty” value between two “filled values” can be filled in via such interpolation.

Finally, as a result of such processing, at 3545, a volume is created, and at 3550 process flow thus ends.

As noted above, with reference to 3510 of FIG. 35, after a set of freehand ultrasound images in 3D space has been acquired, an optional slice reduction optimization can be implemented. This will next be described in connection with FIG. 43.

With reference thereto, process flow begins at 4300. At 4305, all of the image slices obtained (such as, for example, at 3505 with respect to FIG. 35) can be marked as “to be included,” thus at this stage all slices are retained. At 4310 a reference number i, used to step through the slices, can be, for example, set to 0 and a reference variable N can be used to store the number of image slices for comparisons, as described below. At 4315, for example, another variable, n, can be used to count slices ahead of the slice under analysis, and at 4315 it can be set to 1.

Thus, after these initial set up processes, at 4320 distances between the four corners of slice i and the four corners of slice i+n are then computed. If these distances are all within a certain threshold, then the two slices are, within a certain resolution, redundant, and need not both be kept. 4325 is a decision process which determines whether the result of 4320 is within a certain threshold. As noted, if the distances between the four corners of slice i and the four corners of slice i+n are respectively all within a defined threshold, then process flow moves to 4330 and slice i is marked as “to be excluded.” If at 4325 the answer is no, then process flow moves to 4326 and n is incremented by 1, stepping ahead to test the next further slice form slice i. Process flow then can move to 4327 where it can be determined whether i+n, i.e., this next further slice, is greater than or equal to N, i.e., if the slice n slices ahead of slice i is greater than N, the total number of slices, slice i+n is not in the acquired slice set and does not exist. If yes, process flow moves to 4335 and i is set to i+1, i.e., the analysis proceeds using slice i+1 as the base, and loops back through 4340 and 4315. At 4340 it is determined whether i is greater than or equal to N. If no, then process flow returns to 4315 and loops down through 4320, 4325, etc., as described above. If yes, then process flow moves to 4345 and essentially the algorithm has completed. At 4345, all image slices that were marked as “to be excluded” can be removed, and at 4350 the algorithm ends.

If at decision 4327 the answer is “no”, and thus slice i+n is still within the acquired slices, then process flow returns to the inner processing loop, beginning at 4320 and continuing down through 4325, as described above.

In this way all slices can be used as a base, and from such base all slices in front of them (accessed by incrementing n) can be tested. Redundant slices can be tagged as “to be excluded” and at processing end, deleted. Redundant slices (i) are deleted form the beginning of the set of slices (thus when slice l and slice i+n are within a defined spatial threshold it is slice i that is tagged to be excluded), so when one is tagged for removal the base slice i can be incremented, as seen at 4335.

The exemplary method of FIG. 43 can thus be used, in exemplary embodiments of the present invention, to cull redundant slices from a set of acquired slices and thus reduce processing in creating a volume out of a set of slices, according to a process as is shown for example, in FIG. 35.

The present invention has been described in connection with exemplary embodiments and implementations, as examples only. It is understood by those having ordinary skill in the pertinent arts that modifications to any of the exemplary embodiments or implementations can be easily made without materially departing from the scope or spirit of the present invention, which is defined by the appended claims.

What is claimed:

1. A method for creating 4D images, comprising:
acquiring a series of 2D images in substantially real time;
mapping each image onto a plane in 3D space with its corresponding 3D position and orientation;
applying a blending function to the series of acquired images; and
rendering the planes in substantially real time.

2. The method of claim 1, wherein the series of images are ultrasound images.

3. The method of claim 1, wherein the resolution of the acquired images is greater than or equal to 128×128;

4. The method of claim 1, wherein the resolution of the acquired images is greater than or equal to 256×256;

5. The method of claim 1, wherein the resolution of the acquired images is greater than or equal to 512×512;

6. The method of claim 1, wherein the blending function is C=A*Wa+B*Wb+ . . . +(N−1)*W(n−1)+N*Wn.

7. The method of claim 1, wherein the corresponding 3D position and orientation of each 2D image is obtained by one or more positional sensors.

8. The method of claim 7, wherein the positional sensors are a 3D tracking system and a tracked ultrasound probe.

9. The method of claim 1, wherein the corresponding 3D position and orientation of each 2D image is either acquired, computed, or both acquired and computed.

10. The method of claim 1, further comprising performing 2D filtering on one or more of the 2D images after acquisition.

11. The method of claim 10, wherein the 2D filtering comprises smoothing and/or noise removal.

12. A computer program product comprising:
a computer usable medium having computer readable program code means embodied therein, the computer readable program code means in said computer program product comprising means for causing a suitable computer to:
acquire a series of images in substantially real time;
map each image onto a plane in 3D space with its corresponding 3D position and orientation;
apply a blending function to all acquired images; and
render the planes in substantially real time.

13. A program storage device readable by a machine, tangibly embodying a program of instructions executable by the machine to perform a method for creating 4D images, said method comprising:
acquiring a series of 2D images in substantially real time;
mapping each image onto a plane in 3D space with its corresponding 3D position and orientation;
applying a blending function to all acquired images; and
rendering the planes in substantially real time.

14. The computer program product of claim 12, wherein said means further causes a computer to perform 2D filtering to one or more of the 2D images after acquisition.

15. The program storage device of claim 13, wherein said method further comprises performing 2D filtering to one or more of the 2D images after acquisition.

16. The method of claim 1, wherein the 4D images are displayed stereoscopically.

17. A method of utilizing all of the 3D data acquired by a high-resolution ultrasound probe in a 4D ultrasound display, comprising:
acquiring a series of 2D images at full resolution in substantially real time;
mapping each image onto a plane in 3D space with its corresponding 3D position and orientation without downsampling;
applying a blending function to the series of acquired images; and
rendering the planes in substantially real time.

19. A method of obtaining a volume from ultrasound images acquired using a 1 D probe, comprising:
acquiring a set of ultrasound slices;
obtaining the position and orientation of each slice;
determining a bounding box that can approximately enclose the entire set of images;
allocating memory for the bounding box;
resampling the acquired slices into the allocated memory; and
interpolating to fill any empty voxels to create a volume.

20. The method of claim 19, wherein the acquired ultrasound slices have different positions and orientations from each other.

21. The method of claim 19, wherein the bounding box is determined by calculating the maximum and minimum offset in the direction of the scan from a reference slice.

22. The method of claim 19, wherein after obtaining the set of slices, a slice reduction optimization is performed.

23. A method of conducting volumetric ultrasound examination, comprising:
performing a initial examination using volumes generated according to the method of claim 1; and
performing a more detailed examination of selected areas using conventional volume rendering of acquired ultrasound slices.
